(19) United States
(12) Patent Application Publication
(10) Pub. No.: US 2026/0080508 A1
(43) Pub. Date: Mar. 19, 2026

(54) MULTI-TRACK VIDEO SYSTEMS AND METHODS

(71) Applicant: Nikon Corporation, Tokyo (JP)

(72) Inventors: Jeff Goodman, Aliso Viejo, CA (US); Loren Simons, Woodland Hills, CA (US); Graeme Nattress, Acton (CA)

(21) Appl. No.: 19/014,010

(22) Filed: Jan. 8, 2025

Related U.S. Application Data
(60) Provisional application No. 63/696,686, filed on Sep. 19, 2024.
(60) Provisional application No. 63/740,822, filed on Dec. 31, 2024.

(51) Int. Cl. G06T 5/50; G06T 7/90; G06V 20/52

(52) U.S. Cl. CPC G06T 5/50; G06T 7/90; G06V 20/52; G06T 2207/20221

(57) ABSTRACT

A video camera system has a multi-track recording mode in which captured digital video frames each have a first sub-frame having a first exposure level and a second sub-frame having a second exposure level different than the first exposure level. For each respective frame of a plurality of digital video frames in the stream, for each respective pixel of a plurality of pixels in the frame, the camera is configured to analyze pixel data for the respective pixel from the first sub-frame and pixel data for the respective pixel from the second sub-frame to determine whether to adjust an amount of blend from a first blending amount to a second blending amount. The camera uses the amount of blend to blend the respective pixel of the first sub-frame together with the respective pixel of the second sub-frame to generate a blended pixel.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

Embodiments disclosed herein relate to multi-track video recording, including for high dynamic range video and/or for virtual digital video production, including for live broadcast, monitoring, virtual production, and other environments.

### SUMMARY

In some aspects, the techniques described herein relate to a video camera system including: an image sensor including an array of sensor pixels, the image sensor configured to capture digital video frames in response to light incident on the array of sensor pixels; and one or more processors configured, when the video camera system is operating in a first multi-track recording mode, to: receive a stream of digital video frames from the image sensor, wherein each of the digital video frames include a first sub-frame having a first exposure level and a second sub-frame having a second exposure level different than the first exposure level; for each respective frame of a plurality of digital video frames in the stream, for each respective pixel of a plurality of pixels in the frame: determine an initial value of a blending parameter for the respective pixel using image data for the respective pixel in the first sub-frame of the respective frame; detect whether ghosting is likely to result from using the initial value to blend the respective pixel of the first sub-frame together with the respective pixel of the second sub-frame; determine a final value of the blending parameter in response to the detection of whether ghosting is likely; and use the final value to blend the respective pixel of the first sub-frame together with the respective pixel of the second sub-frame to generate a blended pixel, the blended pixel included in a blended digital video frame corresponding to the respective frame; and the one or more processors further configured, when the video camera system is operating in the first multi-track operating mode, to output a stream of the blended digital video frames for monitoring.

In some aspects, the techniques described herein relate to a video camera system wherein the one or more processors are configured to determine the initial value of the blending parameter using first image data corresponding to a single color of the respective pixel in the first sub-frame.

In some aspects, the techniques described herein relate to a video camera system wherein the first image data is a minimum R, G, or B value of an RGB triplet of the respective pixel of the first sub-frame.

In some aspects, the techniques described herein relate to a video camera system wherein the one or more processors are configured to detect whether ghosting is likely based on i) the first image data corresponding to a single color of the respective pixel in the first sub-frame and ii) second image data that corresponds to a single color of the respective pixel in the second sub-frame.

In some aspects, the techniques described herein relate to a video camera system wherein the one or more processors are configured to: use the initial value of the blending parameter to blend the first image data and the second image data to generate blended image data; and detect whether ghosting is likely by comparing the first image data to the blended image data.

In some aspects, the techniques described herein relate to a video camera system wherein the first image data corresponds to a minimum R, G, or B value of an RGB triplet of the respective pixel of the first sub-frame, and the second image data corresponds to a minimum R, G, or B value of an RGB triplet of the respective pixel of the second sub-frame.

In some aspects, the techniques described herein relate to a video camera system wherein the one or more processors are configured to: set the final value to be the initial value in response to a determination that ghosting is unlikely; and set the final value to be a value different than initial value in response to a determination that ghosting is likely.

In some aspects, the techniques described herein relate to a video camera system wherein the setting the final value to be a value different than the initial value results in less of the respective pixel of the second sub-frame, and more of the respective pixel of the first sub-frame, being included in the blended pixel than would have been the case if the final value were set as the final value.

In some aspects, the techniques described herein relate to a video camera system further including one or more monitoring ports, where the stream of the blended digital video frames is output on at least one of the one or more monitoring ports.

In some aspects, the techniques described herein relate to a video camera system wherein the one or more processors are further configured, for each frame of the plurality of digital video frames, to apply a gain to the pixels in at least the second sub-frame, and to apply log encoding to the pixels in the first and second sub-frames, the log encoding applied after the gain.

In some aspects, the techniques described herein relate to a video camera system wherein the application of the gain balances tonal values between the first sub-frame and the second sub-frame.

In some aspects, the techniques described herein relate to a video camera system further including a monitoring port configured to provide the stream of blended digital video frames to a monitor connected to the monitoring port for real-time display.

In some aspects, the techniques described herein relate to a video camera system wherein the blended digital video frame has a higher dynamic range than either of the first sub-frame or the second sub-frame.

In some aspects, the techniques described herein relate to a video camera system wherein, when the video camera system is operating in a second multi-track recording mode, the one more processors are configured to: receive a stream of the digital video image frames from the image sensor, wherein each of the digital video frames include a first sub-frame that captures a first virtual production background and a second sub-frame that captures a second virtual digital production background; separate the first sub-frames into a first track and the second sub-frames into a second track; and output the first track and the second track as separate streams.

In some aspects, the techniques described herein relate to a video camera system wherein, when the video camera system is operating in the first multi-track recording mode, the one or more processors are configured to write the stream of the blended digital video frames is written in a single file to memory, and when the video camera is operating in the second multi-track recording mode, one or more processors are configured to write the first track and the second track as separate files to memory.

In some aspects, the techniques described herein relate to a video camera system further including at least two monitoring ports, wherein, when the video camera system is operating in the first multi-track recording mode, the stream of blended digital video frames is output on at least one of the at least two monitoring ports, and wherein, when the video camera is operating in the second multi-track recording mode, the first track is output on a first of the at least two monitoring ports and the second track is output on a second of the at least two monitoring ports.

In some aspects, the techniques described herein relate to a method of operating a video camera system, the method including: when the video camera system is operating in a first multi-track recording mode: capturing digital video frames using an image sensor of the camera system in response to light incident on an array of sensor pixels; receiving a stream of digital video frames from the image sensor, wherein each of the digital video frames include a first sub-frame having a first exposure level and a second sub-frame having a second exposure level different than the first exposure level; with one or more processors of the video camera system, for each respective frame of a plurality of digital video frames in the stream, for each respective pixel of a plurality of pixels in the frame: determining an initial value of a blending parameter for the respective pixel using image data for the respective pixel in the first sub-frame of the respective frame; detecting whether ghosting is likely to result from using the initial value to blend the respective pixel of the first sub-frame of the frame together with the respective pixel of the second sub-frame; determining a final value of the blending parameter in response to the detection of whether ghosting is likely; and using the final value to blend the respective pixel of the first sub-frame together with the respective pixel of the second sub-frame to generate a blended pixel, the blended pixel included in a blended digital video frame corresponding to the respective frame; and outputting a stream of the blended digital video frames for monitoring.

In some aspects, the techniques described herein relate to a method wherein the determining the initial value of the blending parameter includes using first image data corresponding to a single color of the respective pixel in the first sub-frame.

In some aspects, the techniques described herein relate to a method wherein the first image data is a minimum R, G, or B value of an RGB triplet of the respective pixel of the first sub-frame.

In some aspects, the techniques described herein relate to a method wherein the detecting whether ghosting is likely is based on i) the first image data corresponding to a single color of the respective pixel in the first sub-frame and ii) second image data that corresponds to a single color of the respective pixel in the second sub-frame.

In some aspects, the techniques described herein relate to a method wherein the one or more processors are configured to: use the initial value of the blending parameter to blend the first image data and the second image data to generate blended image data; and detect whether ghosting is likely by comparing the first image data to the blended image data.

In some aspects, the techniques described herein relate to a method wherein the first image data corresponds to a minimum R, G, or B value of an RGB triplet of the respective pixel of the first sub-frame, and the second image data corresponds to a minimum R, G, or B value of an RGB triplet of the respective pixel of the second sub-frame.

In some aspects, the techniques described herein relate to a method, wherein determining the final value includes: for first respective pixels of the plurality of pixels in the frame, setting that the final value to be the initial value in response to a determination that ghosting is unlikely; and for second respective pixels of the plurality of pixels in the frame, setting the final value to be a value different than initial value in response to a determination that ghosting is likely.

In some aspects, the techniques described herein relate to a method wherein the setting the final value to be a value different than the initial value results in less of the respective pixel of the second sub-frame, and more of the respective pixel of the first sub-frame, being included in the blended pixel than would have been the case if the initial value were used as the final value.

In some aspects, the techniques described herein relate to a method further including outputting the stream of the blended digital video frames to at least a first monitoring port of one or more monitoring ports of the video camera system.

In some aspects, the techniques described herein relate to a method further including, for each frame of the plurality of digital video frames in the stream, applying a gain to the pixels in the second sub-frame to balance tonal values between the first sub-frame and the second sub-frame.

In some aspects, the techniques described herein relate to a method further including displaying the stream of blended digital video image frames on a video display connected to the video camera system.

In some aspects, the techniques described herein relate to a method wherein the blended digital video frame has a higher dynamic range than either of the first sub-frame or the second sub-frame.

In some aspects, the techniques described herein relate to a method wherein the first multi-track mode is one of multi-multi-track modes including a second multi-track recording mode in which first sub-frames capture a first virtual production background and second sub-frames captures a second virtual digital production background.

In some aspects, the techniques described herein relate to a method wherein, when the video camera system is operating in the first multi-track recording mode, the stream of the blended digital video frames is written in a single file.

In some aspects, the techniques described herein relate to a video camera system including: an image sensor; and one or more processors configured, when the video camera system is operating in a multi-track recording mode, to: receive a stream of digital video frames from the image sensor, wherein each of the digital video frames include a first sub-frame having a first exposure level and a second sub-frame having a second exposure level different than the first exposure level; for each respective frame of a plurality of digital video frames in the stream, for each respective pixel of a plurality of pixels in the frame: analyze pixel data for the respective pixel from the first sub-frame and pixel data for the respective pixel from the second sub-frame to determine whether to adjust an amount of blend from a first blending amount to a second blending amount; and use the amount of blend to blend the respective pixel of the first sub-frame together with the respective pixel of the second sub-frame to generate a blended pixel.

In some aspects, the techniques described herein relate to a video camera system wherein the amount of blend used is equal to the first blending amount if the analysis indicates that ghosting is unlikely, and the amount of blend used is adjusted to the second amount of blend if the analysis indicates that ghosting is likely.

In some aspects, the techniques described herein relate to a video camera system wherein, for at least some respective pixels of the plurality of pixels, the second blending amount is less than the first blending amount.

In some aspects, the techniques described herein relate to a video camera system wherein, for at least some respective pixels of the plurality of pixels, the first blending amount is non-zero blend and the second blending amount is zero blend.

In some aspects, the techniques described herein relate to a virtual production system including: at least a first virtual production display device; a first computing device coupled to the first virtual production display device and including one or more processors that execute a virtual production control engine, the virtual production control engine configured to control the first virtual production display device such that the first virtual production display device alternatingly displays at least a first virtual production background and a second virtual production background; and at least a first video camera including: an image sensor configured to capture digital video image frames in response to light incident on the image sensor; and one or more processors configurable, when the first video camera is operating in a multi-track virtual production recording mode, to: receive a stream of the digital video image frames from the image sensor, wherein first frames in the stream of digital video image frames capture the first virtual production background and second frames in the stream of digital image frames capture the second virtual production background, wherein the first frames and the second frames alternate in the stream of the digital video image frames; and separate the stream of the digital video image frames into a first track including the first frames and a second track including the second frames.

In some aspects, the techniques described herein relate to a virtual production system wherein the one or more processors of the first video camera are further configured to format the first track into a first file, format the second track into a second file, and record the first file and the second file in memory.

In some aspects, the techniques described herein relate to a virtual production system wherein the first virtual production background corresponds to a non-green screen virtual set and the second virtual production background corresponds to a green screen virtual set.

In some aspects, the techniques described herein relate to a virtual production system wherein one or both of the first virtual production background and the second virtual production background include recorded motion video, and the virtual production control engine is configured to provide digital video data to the first virtual production display device corresponding to the recorded motion video.

In some aspects, the techniques described herein relate to a virtual production system wherein one or both of the first virtual video production background and the second virtual production background include computer-generated imagery, and the virtual production control engine is configured to provide digital data to the first virtual production display device corresponding to the computer-generated imagery.

In some aspects, the techniques described herein relate to a virtual production system wherein the virtual production control engine is further configured to alternatingly output first digital image data corresponding to the first virtual production background and second digital image data corresponding to the second virtual production background.

In some aspects, the techniques described herein relate to a virtual production system further including a synchronization generator coupled to provide a synchronization signal to each of the first computing device and to the first video camera, the first computing device configured in response to the synchronization signal to adjust a timing of the display of the alternating display of the first virtual production background and the second virtual production background, and the first video camera configured in response to the synchronization signal to adjust a timing of the capture of the digital video image frames.

In some aspects, the techniques described herein relate to a virtual production system wherein the first virtual production display device includes an LED display.

In some aspects, the techniques described herein relate to a video camera including: a housing; an image sensor within the housing and configured to output raw, mosaiced digital image data in response to light incident on the image sensor; and one or more processors configurable, when the video camera is operating in a multi-track virtual production recording mode, to: receive a stream of digital image frames from the image sensor at a first frame rate, wherein alternating frames in the stream of the digital image frames correspond to N virtual production environment configurations, where N is at least two; separate the digital image frames into N separate tracks; format the N separate tracks as N separate files; and record the N separate files into memory.

In some aspects, the techniques described herein relate to a video camera wherein the one or more processors are further configured, when the video camera is operating in a multi-track virtual production recording mode, to set a frame rate of the video camera to be at least N*F, where F is a frame rate of each of the N separate tracks.

In some aspects, the techniques described herein relate to a video camera wherein the one or more processors are further configured, when the video camera is operating in a multi-track virtual production recording mode, to compress the digital image frames.

In some aspects, the techniques described herein relate to a video camera wherein the compression occurs prior to the separation of the digital image frames into N separate tracks.

In some aspects, the techniques described herein relate to a video camera wherein the compression occurs after the separation of the digital image frames into N separate tracks.

In some aspects, the techniques described herein relate to a video camera further including a plurality of video streaming output ports, and the one or more processors are further configurable, when the video camera is operating in a multi-track virtual production recording mode, to output the N separate tracks for streaming off the video camera via the plurality of video streaming output ports.

In some aspects, the techniques described herein relate to a video camera further including a plurality of video streaming output ports, and the one or more processors are further configurable, when the video camera is operating in a multi-track virtual production recording mode, to output the N separate files for streaming off the video camera via the plurality of video streaming output ports.

### BRIEF DESCRIPTION OF THE DRAWINGS

Embodiments of this disclosure will now be described, by way of non-limiting example, with reference to the accompanying drawings, like reference numerals can refer to similar features throughout.

FIGS. 1A-1C depict an embodiment of a virtual production environment including a group of light emitting diode (LED) volume panels, during time periods in which the LED volume walls are respectively projecting a day landscape scene, a night landscape scene, and a green screen.

FIG. 2 depicts an example of a video production system that can form part of a virtual production environment such as the one of FIGS. 1A-1C, according to certain embodiments.

FIG. 3A is a plot showing timing of various events in a multi-track recording scenario implemented by a video production system according to certain embodiments.

FIG. 3B shows multiple virtual production tracks that can be recorded or streamed by a video camera in a virtual production system according to certain embodiments.

FIG. 4A-4C respectively depict front, rear, and perspective views of an embodiment of a digital video camera capable of recording or streaming multiple tracks, such as for recording in a virtual production environment.

FIG. 5 depicts a schematic block diagram of a video camera, such as the video camera of FIGS. 4A-4C.

FIG. 6 depicts a schematic block diagram of an image processing system of a video camera, such as the image processing system of the video camera of FIG. 5, according to certain embodiments.

FIG. 7 depicts a video system according to certain embodiments that includes a digital video camera capable of capturing multiple differently exposed tracks and streaming an on-camera blended stream of the tracks to a monitor for real-time viewing. The system further includes a post-processing computing system capable of blending the tracks.

FIG. 8 depicts a schematic block diagram of a video camera, such as the video camera of FIG. 7, according to certain embodiments.

FIG. 9 depicts a schematic block diagram of an image processing system of a video camera, such as the image processing system of the camera of FIG. 7 or FIG. 8, according to certain embodiments.

FIG. 10A shows a flow chart of an example method of multi-track camera operation depending on user selection of a virtual production multi-track mode or an HDR multi-track mode, according to certain embodiments.

FIG. 10B shows a flow chart of an example of a method for capturing multiple differently exposed video tracks and performing a reduced-complexity blend of the tracks, e.g., for real time monitoring/viewing, according to certain embodiments.

FIG. 10C shows a flow chart of an example of an algorithm for performing a reduced-complexity blend of multiple differently exposed video tracks, according to certain embodiments.

### DETAILED DESCRIPTION OF CERTAIN EMBODIMENTS

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

### I. Digital Video Virtual Production Systems and Methods Using Multi-track Recording

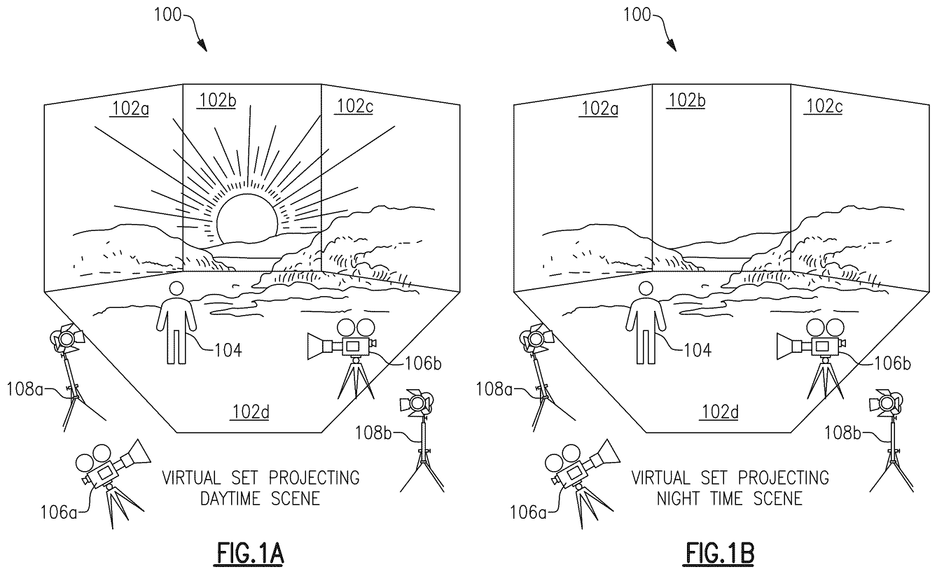

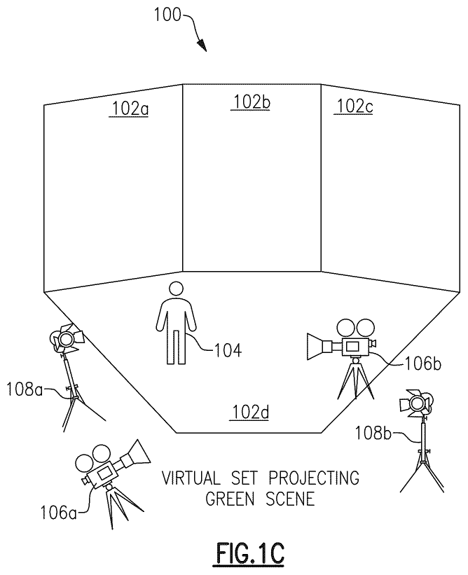

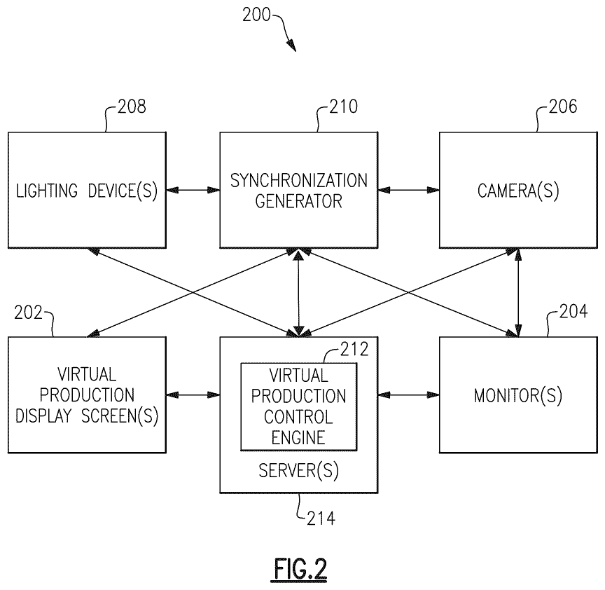

FIGS. 1A-1C depict an embodiment of a virtual production environment 100 including a group of virtual production display screens or panels 102, during time periods in which the virtual production screens 102 are projecting a day landscape scene (FIG. 1A), a night landscape scene (FIG. 1B), and a green screen (FIG. 1C).

While FIGS. 1A-1C depict landscape, night, and green screen scenes, this is only for the purposes of illustration. Users can configure the screens 102 to display a wide variety of different scenes depending on the use case. For instance, users can configure the screens 102 display only a single non-green scene instead of both day and night scenes, facilitating recording of a single non-green screen track together with a green screen track, instead of three tracks. Or, as another example, instead of day and night scenes, the virtual production panels 102 in a different use case can be configured to display a first scene with overlaid sub-titles or other text in a first language and a second scene with overlaid sub-titles or other text in a second language, facilitating simultaneous recording of tracks for audiences that speak two different languages. Moreover, the screens 102 can be configured to display four or more different scenes (e.g., day, night, day augmented overlaid graphics/text, night augmented with overlaid graphics/text), facilitating recording of four or more tracks.

The virtual production panels 102 can include one or more digital displays such as a plurality of LED-based displays. In some embodiments, the virtual production panels 102 are so called “LED volumes” or “LED volume walls.” LED volumes can provide advantages over other types of virtual production technologies, such as static green screens, because LED volumes can achieve more realistic footage by creating realistic reflections and shadows, thereby enhancing the authenticity of the virtual environment 100, and can also provide actors, directors, and other personnel with real-time scene context.

As will be discussed in further detail, the virtual production panels 102 can be driven by a computer graphics software application running on one or more computers, such as the Unreal Engine provided by Epic Games, Inc., or some other 3D graphics engine.

The particular arrangement of the virtual production panels 102a-102d in the illustrated virtual production environment 100 includes three vertical panels 102a-102c and a floor panel 102d. The virtual production panels 102 can be connected to a digital video source, such that the virtual production panels 102 can be configured to project generally any type of recorded or computer-generated scene.

Depending on the use case, in other embodiments other types of display technology (e.g., liquid crystal displays [LCD]) and/or other numbers of panels can be used. For example, while not shown in FIG. 1A-1B for simplicity, the virtual production panels 102 can include one or more ceiling panels above the wall panels 102a-102c, opposite the floor panel 102d, and which can display a sky, building ceiling, etc., depending on the scene.

In the illustrated environment 100, an actor 104 is standing on the floor panel screen 102d in front of the three wall panel screens 102a-102c. The environment 100 further includes one or more digital video cameras 106a, 106b is positioned to record the actor 104 and the virtual production panels 102. The cameras can record independent feeds or can record tracks for combination, such as to generate 3-dimensional footage depending on the use case. The cameras 106a, 106b can also be configured to record and/or stream separate tracks corresponding to a plurality of virtual production scenes. For example, the cameras 106a, 106b can be configured through a menu setting or other appropriate user input to record two, three, four, or more separate tracks corresponding to an equal number of different scenes displayed by the virtual production screens 102. In the scenario depicted by FIGS. 1A-1C, for instance, as will be discussed in further detail, the cameras 106a, 106b can be configured by the user to record three tracks, one corresponding to each of the day scene, the night scene, and the green screen scene, to synchronize the capture of the scenes with the changing of the scenes by the virtual production screens 102. The cameras 106a, 106b can further be configured to separate out the three tracks for recording as discrete files or for streaming separately, such as to separate camera serial digital interface (SDI) or other output ports.

The environment 100 further includes one or more lighting devices 108a, 108b arranged to provide custom lighting to the environment 100. For example, the lighting devices 108a, 108b can be LED-based studio light panels, which can include an array of bi-color (e.g., warm and cool) LEDs or red-green-blue (RGB) LEDs and which can be controlled to adjust the output intensity and/or color. A wide variety of other lights can be used, depending on the implementation.

In some embodiments, the lighting devices 108a, 108b can be similar to or the same as virtual display screens 102 (e.g., an LED volume), but configured to provide lighting instead of background.

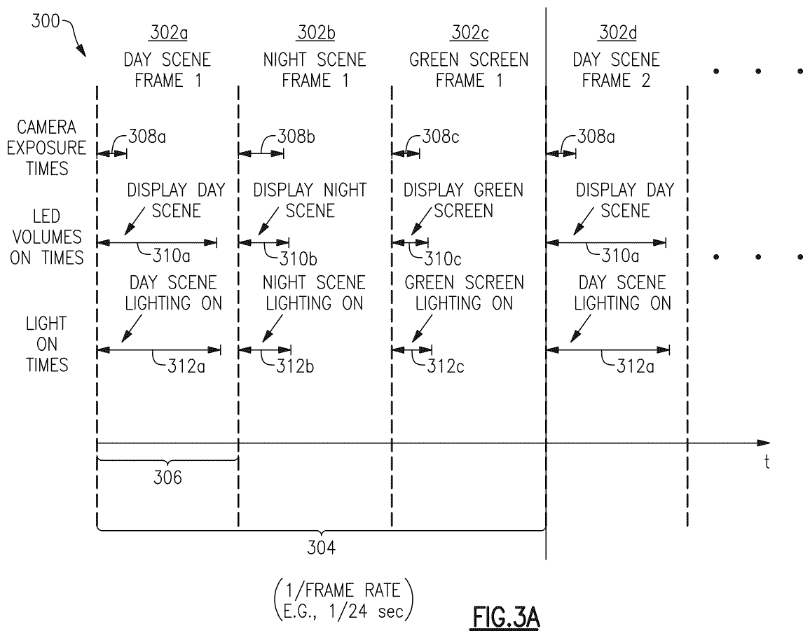

FIG. 2 shows an example of an example of such a video production system 200 according to certain embodiments, and which can be used with the virtual production environment of FIGS. 1A-1C.

The illustrated system 200 includes one or more virtual production display screens 202, one or more monitors 204, which can be any type of display for monitoring streamed or recorded video or background, one more cameras 206, one or more lighting devices 208, a synchronization generator 210, and a virtual production control engine 212 executing on one or more servers or other computing devices 214.

As shown, the virtual production control engine 212 can be coupled to some or all the other components in the system 200 via digital video cables (e.g., optical or copper) or networking cables (e.g., copper Ethernet cables), or via another appropriate type of cable or wireless connection. The control engine 212 can include one or more software applications executing on the servers 214 and configured to orchestrate the virtual production. For instance, the control engine 212 can include a computer graphics engine for generating, rendering, and/or manipulating imagery for displaying on the display screens. The imagery can include computer-generated imagery, recorded video or still images, or a combination thereof. For example, the control engine 212 can include the Unreal Engine or another 3D graphics engine.

The control engine 212 can also provide a user interface allowing users to adjust various settings, such as to adjust or swap the background scenery displayed on the display screens 202, to adjust the lighting provided by lighting devices 208, to control operation of the cameras 206, select which background or camera feeds go to which of the monitors 204, etc.

The virtual production display screens 202 can include the virtual production panels 102a-102d of FIGS. 1A-1C, such as one or more LED volume panels, or any other type of virtual production display.

The cameras 206 can be any of the cameras described herein (e.g., with respect to FIGS. 1 and 4-6) configured for recording and/or streaming multiple tracks of video, e.g., where each track corresponds to a different background projected by the virtual production display screens 202.

The lighting devices 208 can be the lighting devices 108 of FIGS. 1A-1C, or some other type of video production lighting devices. For instance, in some embodiments, the lighting devices 208 are LED screens and, like the virtual display screens 202, can be driven by the Unreal Engine or another computer graphics engine, to provide lighting effects customized and synchronized to the scene that is currently displayed on the virtual display screens 102a-102d. In some cases, one or more of the lighting devices 108 can be configured to be dedicated to providing lighting while the display screens 202 are projecting a first background scene and one or more other lighting devices 208 can be dedicated to providing lighting while the display screens 202 are projecting a second, different scene. As one example, referring to FIG. 1A-1C, the first lighting device 108a could be configured to operate to provide lighting customized to the daytime scene, while the virtual production panels 102a-102d are projecting the daytime scene, and the second lighting device 108b could be configured to provide lighting customized to the nighttime scene, only while the virtual production panels 102a-102d are projecting the night time scene. For example, the virtual production control engine 212 could operate to synchronize such operation of the lighting devices 208 with operation of the display screens 202, by activating and deactivating the respective lighting devices 208 synchronous with the display screens 202.

The monitors 204 can be coupled to the cameras 206 and/or the virtual production control engine 212 to allow for live viewing of various feeds or playback of recorded video. For example, referring to FIGS. 1A-1C for the purposes of illustration, in one implementation, the monitors 204 include three separate video displays each coupled via a cable to a different SDI output port of the first camera 106a, each SDI output port providing one of a day scene track, a night scene track, and a green screen track captured by first camera 106a. The monitors 204 in this implementation further include three additional displays each coupled via a cable to a different SDI output port of the second camera 106b, each SDI output port providing one of a day scene track, a night scene track, and a green screen track captured by the second camera 106b. In this exemplary implementation the monitors 204 can further include three additional displays each coupled via a cable to a different output provided by the servers 214, where each output provides one of a video feed corresponding to the day scene, a video feed corresponding to the night scene, or a video feed corresponding to the green screen. For example, the outputs from the servers 214 can provide a duplicate of the video streams generated by the virtual production control engine 212 and provided to the virtual production display screens 202. In this fashion, the monitors 204 can provide simultaneous viewing of separate streamed or played back tracks captured by each of the first and second cameras 106a, 106b during display of the day scene, night scene, and green screen track, as well as viewing of the different background feeds (e.g., video or CGI feeds) themselves. In other implementations, there is not a separate monitor for every feed, and instead one or more of the monitor(s) are segmented to present multiple feeds in different portions of a single display.

As shown, the synchronization generator 210 can be configured to provide Genlock or other synchronization signals to some or all the other components in the system 200 to synchronize operation of the various devices to a common video frame boundary.

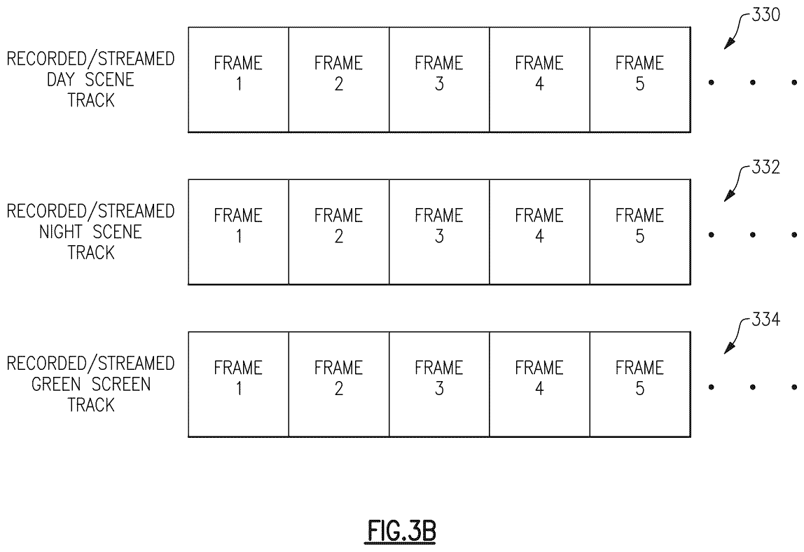

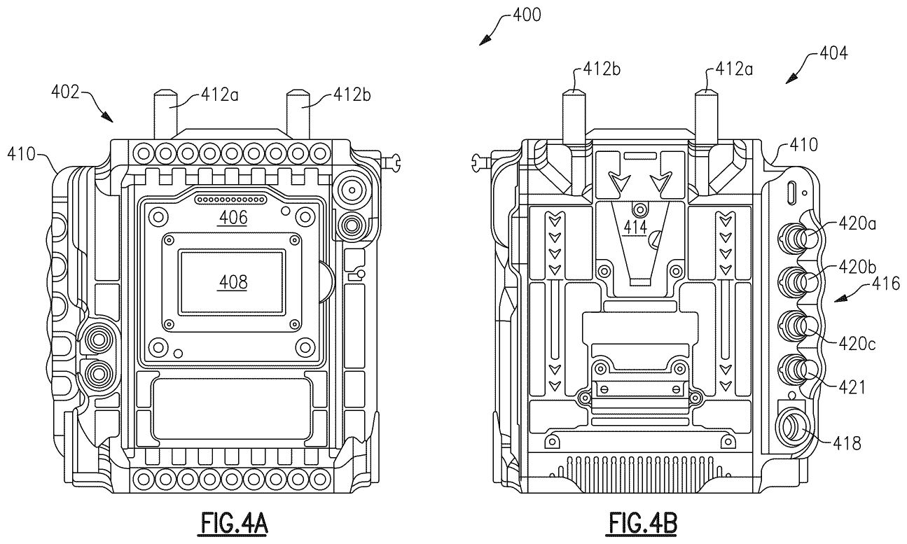

FIG. 3 is a timing diagram 300 illustrating operation of an example virtual video production system, which will be described with reference to the systems of FIGS. 1A-1C and FIG. 2. In the exemplary scenario, the camera(s) 206 are configured to capture three tracks including a day scene track, a night scene track, and a green scene track. The timing diagram 300 shows operation during windows 302a, 302b, 302c during which a first frame is captured for each of the three respective tracks. FIG. 3 also shows operation during window 302d during which the second frame is captured for the day scene track. While FIG. 3 shows only a first frame and one-third of a second frame for the purposes of illustration, it will be appreciated that additional frames continue to be captured on an alternating basis during operation.

An effective frame period 304 of each track is one divide by an effective frame rate of the tracks. Because the individual frames for each track are captured sequentially within the effective frame period 304, the individual frames are each captured within a smaller sub-frame period 306. As one example, where the effective frame rate of each track is 24 frames per second (fps), the effective frame period 304 is 1/24 of a second, and the sub-frame period 306 is one-third of the effective frame period, i.e., 1/72 of a second. Thus, while the effective frame rate of each track is 24 fps in this example, the actual frame rate of the camera(s) 204 is set to at least 72 fps to allow for sequential capture of three frames during each effective frame period 304, one frame for each of the day, night, and green screen tracks.

As shown, the camera(s) 202 can be configured to have exposure times 308a, 308b, 308c for each track, e.g., during which pixels of an image sensor of the camera(s) 206 are activated to detect light. The exposure times 308a, 308b, 308c can all be the same or can vary based on the track. For example, in the illustrated embodiment, the day scene track has a shorter exposure time 308a than either of the exposure time 308b of the night scene track or the exposure time 308c of the green screen track. The virtual production control engine 212 can be configured to control the camera(s) 206 to set the exposure times, or a user can set the exposure times using an interface of the camera(s) 206, depending on the embodiment.

The virtual production display screens 202 can be controlled by the virtual production control engine 212 to have on-time periods 310a, 310b, 310c corresponding to the different virtual backgrounds. For example, in the illustrated embodiment, the control engine 212 outputs a video stream to the display screen(s) 202 causing it to display the day scene for an on-time period 310a during a portion of the sub-frame window 302a, then changes the video stream to cause the screen(s) 212 to display the night scene for an on-time period 310b during a portion of the next sub-frame window 302b, and then changes the video stream to cause the screen(s) 212 to display the green screen for an on-time period 310c during a portion of the third sub-frame window 302c. The on-time period 310a for displaying the day scene can be significantly longer (e.g., 2, 3, 5, 10, 100 or more times longer) than the on-time periods 310b, 310c for displaying the night and green screen scenes. This can cause the day scene to be visible to individuals physically present in the virtual production environment, whereas because the on-time periods 310b, 310c of the night scene and green screen scenes are much shorter, the night scene and green screen turn on and off too fast for the user to actually see them, while at the same time providing sufficient time for the camera(s) 206 to capture them during the exposure times 308b, 308c, respectively. In this manner, the system 200 can display a single visible background to those in the production environment while simultaneously recording multiple backgrounds. The virtual production control engine 212 can be configured via a user interface to allow the user to select a different scene for visibility on set. For example, if the user selects the night scene as the currently visible background, the control engine 212 can increase the on-time 310b of the night scene and shorten the on-time 310a of the day scene.

The lighting devices 208 can also be controlled by the virtual production control engine 212 to have on-time periods 312a, 312b, 312c corresponding to the different virtual backgrounds.

For example, in the illustrated embodiment, the control engine 212 controls one or more of the lighting devices 208 to output lighting for an on-time period 312a during a portion of the sub-frame window 302a corresponding to the day scene. The on-time period 312a may be the same as the on-time period 310a of the display screen(s) 202, for example. The control engine 212 may be configured to activate a subset of the lighting devices 208 or all of the lighting devices 208 during the first sub-frame window 302a. For example, referring to FIGS. 1A-1C, in one implementation, the first lighting device 108a is dedicated to providing lighting during the day scene, and the control engine 212 controls the first lighting device 108a to activate during the first sub-frame window 302a while the second lighting device 108b is off. The control engine 212 may provide a lighting control input to the first lighting device 108a to cause the first lighting device 108a to output light that is customized to the day scene, for example.

Similarly, the control engine 212 controls one or more of the lighting devices 208 to output lighting for an on-time period 312b during a portion of the sub-frame window 302b corresponding to the night scene. The on-time period 312b may be the same as the on-time period 310b of the display screen(s) 202, for example. The control engine 212 may be configured to activate a subset of the lighting devices 208 or all of the lighting devices 208 during the second sub-frame window 302b. For example, referring to FIGS. 1A-1C, in one implementation, the second lighting device 108b is dedicated to providing lighting during the night scene, and the control engine 212 controls the second lighting device 108b to activate during the second sub-frame window 302b while the first lighting device 108a is off. The control engine 212 may provide a lighting control input to the second lighting device 108b to cause the second lighting device 108b to output light that is customized to the night scene, for example.

The control engine 212 can additionally control one or more of the lighting devices 208 to output lighting for an on-time period 312c during a portion of the sub-frame window 302c corresponding to the green screen scene. The on-time period 312c may be the same as the on-time period 310c of the display screen(s) 202, for example. The control engine 212 may be configured to activate a subset of the lighting devices 208 or all of the lighting devices 208 during the third sub-frame window 302c. For example, referring to FIGS. 1A-1C, in one implementation, both the first and second lighting device 108a, 108b may be configured to provide lighting during the green screen scene, and the control engine 212 controls the first and second lighting devices 108a, 108b to activate during the third sub-frame window 302c. The control engine 212 may provide a lighting control input to the lighting devices 108a, 108b to cause the lighting devices 108a, 108b to output light that is customized to the green screen scene, for example.

While FIG. 3A illustrates a scenario where the camera exposure time windows 308, LED volume on time windows 310, and light on time windows 312 each begin at the beginning of the respective track windows 302, in some embodiments, the camera(s) 206 can be configured (e.g., by user through a GUI) to move the beginning of the exposure times 308 within the respective window 302, such as to the middle, towards the end, or to another position within the respective track window 302. Similarly, the control engine 212 can control the virtual production display screens 202 and/or lighting devices to move the LED volume on time windows 310 and/or light on time windows 312 to be synchronized with the respective camera exposure time window 308, e.g., such that the entirety of each exposure time window 308 falls within the respective LED volume on time window 310 and/or respective light on time window 312. Moreover, while in the illustrated embodiment each of the sub-frame periods 306 are the same, and the three track windows 302 per frame are therefore of the same duration, which is ⅓ of the frame period 304 in FIG. 3A, in other cases, the sub-frame period 306 can vary between the different track windows 302 (e.g., based on user configuration through a GUI). In one such case, the day scene track window 302a consumes ½ of the frame period 304, the night scene track window 302b consumes ¼ of the frame period 304, and the green screen track window 302c consumes the remaining ¼ of the frame period 304. Moreover, this configurability of the duration of the track windows 302 can be combined with the ability to move the exposure time windows 308, the LED volume on time windows 310, and the light on time windows 312 within the respective track window 302.

FIG. 3B shows multiple virtual production tracks 330, 332, 334 that can be recorded or streamed by a video camera in a virtual production system according to certain embodiments. As shown, each track comprises a plurality of image frames, each of which can be represented as a compressed or uncompressed image. The camera(s) 206 can record the tracks 330, 332, 334 as three separate logically organized and independently accessible files having appropriate metadata. The files can be R3D files compressed using RED Digital Cinema's R3D compressed RAW file format, for example. The camera(s) 206 can also be configured to stream the tracks 330, 332, 334 off camera as three separate compressed or uncompressed streams, e.g., to separate SDI ports of the camera(s) 206, either in real time for live viewing or when playing back tracks that have been recorded to the camera(s) memory.

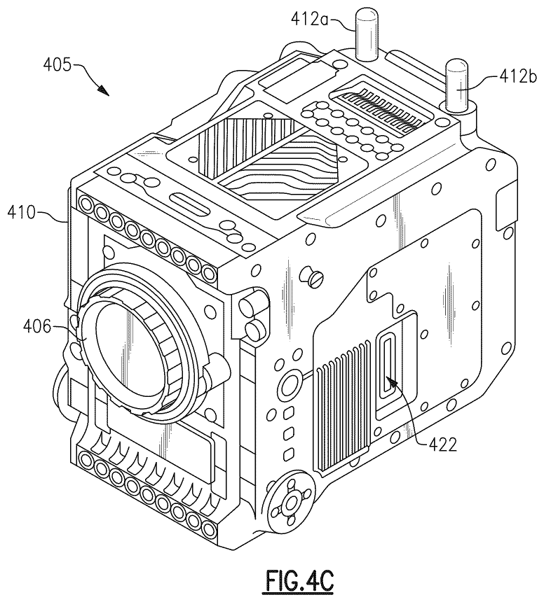

FIG. 4A-4C respectively depict front 402, rear 404, and perspective 405 views of an embodiment of a digital video camera 400 capable of recording or streaming multiple tracks, such as for recording in a virtual production environment. For example, the camera 400 of FIG. 4 can be one of the cameras 106a, 106b of FIGS. 1A-1C or the the camera 206 of FIG. 2.

The camera 400 includes an interface 406 for attaching a lens mount 407 (shown in FIG. 4C). The front of the camera body 410 has a window 408 (shown in FIG. 4A) providing access for light to enter the camera housing 410 and be detected by an image sensor arranged within the camera housing 410.

The camera 400 includes a pair of antennas 412a, 412b for sending and receiving wireless signals. For example, the first antenna 412a can be a Wi-Fi antenna and the second antenna 412b can an Ambient Communications Network (ACN) antenna configured to receive wireless Genlock and Timecode signals, e.g., for synchronizing camera operation to an external source such as a timecode generator providing timestamps to each camera.

A v-mount 414 is supported by the rear of the camera housing 410 is provided for releasably attachment of a battery or other module to the housing. A connection interface includes a DC power input port 418, three SDI ports 420a-420c (e.g., 12G-SDI ports) for connecting to SDI monitor(s), and a Genlock port 421 for receiving a Genlock signal. For example, the synchronization generator 210 of FIG. 2 can be coupled to the camera 400 via a cable connected to the Genlock port 421 or wirelessly via the antenna 412b to provide Genlock or Timecode signals. Moreover, the camera 400 can be connected to up to three monitor(s) 204 via the SDI ports 420a-420c.

As shown in FIG. 4C, the housing of the camera 500 can include a memory card slot 422 for receiving a CF memory card or other memory device for storing video files, including compressed raw video files for multiple separate files corresponding to different virtual production backgrounds, for example.

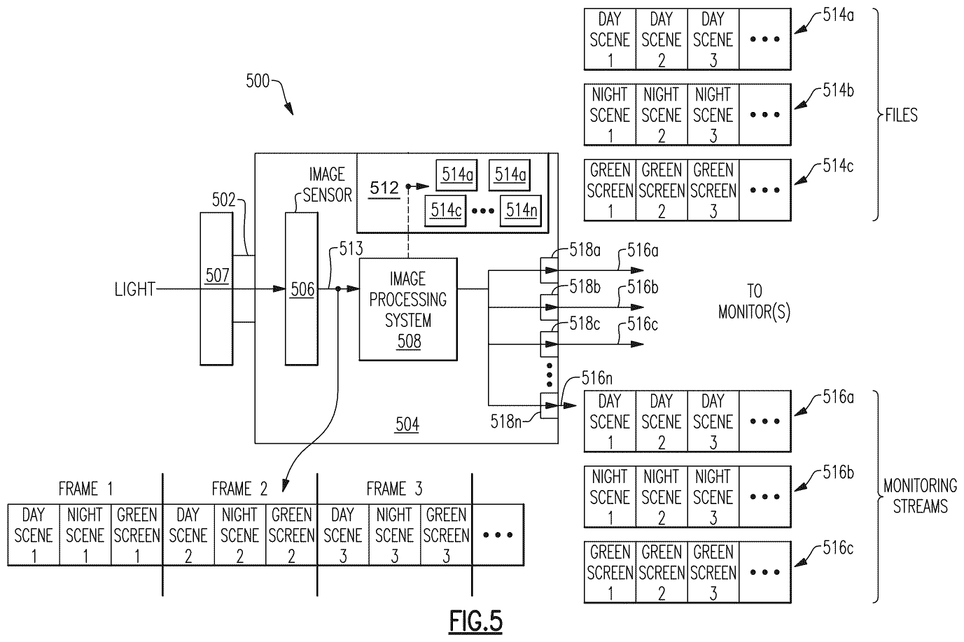

FIG. 5 depicts a schematic block diagram of a video camera 500, such as the video camera of FIGS. 4A-4D and 4F. The camera 500 includes a lens mount 502, which can be fixedly or releasably attached to the camera body housing 504. The lens mount 502 is configured to accept a lens 507 (e.g., a standard lens or a fisheye lens).

An image sensor 506 is contained within the camera body housing 504 and is arranged such that light focused by the lens is detected by an array of pixels of the image sensor 506. The image sensor 506 converts light into digital video image data

The image sensor 506 can be for example, but without limitation, CMOS, CCD, or a multi-sensor array using a prism to divide light between the sensors. The image sensor 506 can be a CMOS global shutter sensor, for example, configured to capture all pixels substantially simultaneously, resulting in reduced distortion or “Jello-effect” when the subject is moving. In other embodiments, a digital rolling shutter can be used. The image sensor 506 can further include a color filter array such as a Bayer pattern filter that outputs data representing magnitudes of red, green, or blue light detected by individual photocells of the image sensor 506. In some configurations, video camera 500 can be configured to output video at 2 k” (e.g., 2048×1080 pixels), “4 k” (e.g., 4,096×2,160 pixels), “4.5 k,” “5 k,” “6 k,” “8 k” (e.g., 8192×4320), “16 k”, or greater resolutions. In one embodiment, image sensor is a 35.4 megapixel (8192 horizontal pixels×4320 vertical pixels) global shutter CMOS sensor. In an exemplary embodiment, the camera 500 can be configured to operate at frame rates of up to 120 frames per second (e.g., at user configurable settings of 24, 48, 96, or 120 fps). As used herein, in the terms expressed in the format of “xk” (such as “2 k” and “4 k” noted above), the “x” quantity refers to the approximate horizontal resolution. As such, “8 k” resolution can correspond to about 8000 or more horizontal pixels, “4 k” resolution can correspond to about 4000 or more horizontal pixels and “2 k” can correspond to about 2000 or more pixels, etc. The image sensor 506 can provide variable resolution by selectively outputting only a predetermined portion of the image sensor 506. For example, the image sensor 506 or the processing system 508 can be configured to allow a user to identify, configure, select, or define the resolution of the video data output. Additional information regarding sensors and outputs from sensors can be found in U.S. Pat. No. 8,174,560, the entire disclosure of which is hereby incorporated by reference herein.

The image sensor 506 can output raw digital image data mosaiced according to the color filter array, such as the example Bayer pattern color filter array. The image processing system 508 can be implemented by software or firmware executing on one or more processors within the camera body housing 504, although in some embodiments the image processing system 508 or portions thereof can be implemented in specialized hardware such as an application-specific integrated circuit (ASIC).

The image processing system 508 receives the raw mosaiced digital image data from the image sensor 506 and can perform one or more functions on the raw mosaiced digital image data to aid in compressing the image data while maintaining the raw, mosaiced nature of the digital image data, and while maintaining substantially visually lossless image quality through compression. According to some embodiments, examples of functionality that can be provided by the image processing system 508 are described in U.S. Pat. No. 10,582,168, titled Green Image Data Processing, which is hereby incorporated by reference herein in its entirety.

The processing system 508 can be configured to compress and/or otherwise process continuous video, e.g., at frame rates of 23.98, 24, 25, 29.97, 30, 47.96, 48, 50, 59.94, 60, 72, 120, 250, frames per second, or other frame rates between these frame rates or greater.

The image processing system 508 can receive a serial stream 513 of frames captured by the image sensor 506 at a rate that is at least n times the frame rate of the n individual tracks. For example, if the user sets the camera 500 to record two tracks (n=2) corresponding to two different virtual production backgrounds at 30 fps, or if a user configures the virtual production control engine 212 to set the camera 500 accordingly, the camera 500 can respond to this setting to internally configure the sensor 506 to capture sequential frames at 2*30 fps=60 fps, where each frame alternates between the two virtual backgrounds. Or if as in the illustrated implementation the camera 500 is set to record tracks at 24 fps, the camera 500 can respond by internally configuring the sensor 506 to capture sequential frames at 3×24 fps=72 fps, where the frames alternate between day, night, and green screen frames.

The image processing system 508 receives the image frame stream 513 from the image sensor 506, performs image processing on the frames as desired (e.g., to compress each frame), organizes the frames into separate tracks, organizes the tracks into files such as by adding appropriate metadata, and writes the tracks into separate files 514a-514n in a memory card or other type of memory device 512. FIG. 5 shows three example tracks for the day scene, the night scene, and the green screen virtual backgrounds. The image processing system 508 can further embed synchronization information in the captured image stream 513 and thus into the recorded and streamed footage, such as timestamp or other synchronization metadata received from a timecode generator, thereby allowing for frame accurate synchronization across multiple cameras having different local clocks.

In addition to being capable of writing the separate files 514a-514n to the memory device 512, the camera 500 can output the separate tracks as separate monitoring streams to 516a-516n to a plurality of output monitor ports 518a-518n. For example, the three monitor ports 518a-518c in some embodiments can be the three monitor ports 420a-420c of the camera 400 of FIGS. 4A-4C.

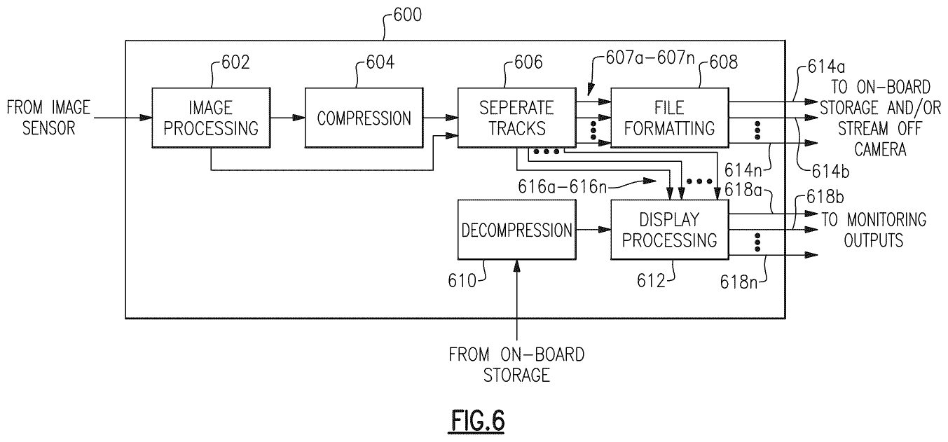

FIG. 6 shows an example of image processing system 600, such as the image processing system 508 of FIG. 5. The image processing system 600 can comprise software or firmware implemented one or more microprocessors, or one or more ASICs or other custom hardware, or any combination thereof.

The image processing system 600 includes an image processing unit 602 that receives the image frame stream from the image sensor and performs appropriate image processing. As an example, where the camera 500 is configured to record or stream compressed raw data, the image processing unit 602 can be configured to perform a pre-emphasis compression tuning operation and/or green average subtraction (GAS) operation to the raw mosaiced Bayer pattern image frames received from the image sensor 506 and output the processed image data to the compression unit 604. U.S. Pat. No. 10,582,168, which is hereby incorporated by reference herein in its entirety, describes examples of image processing modules and corresponding operations (e.g., pre-emphasis, GAS, Green-GAS, and de-noising) that can be incorporated into the image processing unit 602. The image processing unit 602 can perform the pre-emphasis using mathematical functions such as those described in the '168 patent, or with Look Up Tables (LUTs). In some other embodiments, the image processing unit 602 performs one of the pre-emphasis functions described in U.S. Pat. No. 11,818,351, titled VIDEO IMAGE DATA PROCESSING IN ELECTRONIC DEVICES, which is hereby incorporated by reference herein in its entirety.

The compression unit 604 can be configured to a compression algorithm to the processed image frames received from the image processing unit 602, such as a mathematically lossy wavelet or discrete-cosine-transform based compression algorithm, e.g., to achieve compression ratios in excess of 4:1, 5:1, 6:1, 8:1, 10:1, or 12:1 or more and remain visually lossless or substantially visually lossless.

U.S. Pat. Nos. 10,582,168 or 11,818,351, titled GREEN IMAGE DATA PROCESSING and VIDEO IMAGE DATA PROCESSING IN ELECTRONIC DEVICES, respectively, the entireties of the disclosures of which are hereby incorporated by reference herein, describe examples of image processing and compression modules and corresponding operations that can be incorporated into the image processing unit 602 and the compression unit 604.

For example, the image processing unit 602 and compression unit 604 can be configured together to compress the raw mosaiced image frames received by the image sensor into compressed raw mosaiced video image frames. Following compression, the compressed image data according to embodiments described herein continues to be raw mosaiced image data, or compressed raw mosaiced image data (for example, mosaiced according to a Bayer pattern color filter array or according to another type of color filter array). The compressed raw image data can be “raw” in the sense that the video data is not “developed”, such that certain image processing image development steps are not performed on the image data prior to compression and storage. Such steps can include one or more of color interpolation (for example, de-Bayering or other de-mosaicing), color processing, tonal processing, white balance, and gamma correction. For example, the compressed raw image data can be one or more of mosaiced (for example, not color interpolated or demosaiced into a full color image), not color processed, not tonally processed, not white balanced, and not gamma corrected. Rather, such steps can be deferred for off-board the camera, such as for off-board post-processing, thereby preserving creative flexibility instead of “baking in” or fixing particular processing decisions and resulting visual look into the compressed image data in camera. In this manner, creative flexibility is preserved because customized image processing steps can be applied following decompression and demosaicing, e.g., in post-processing. Thus, the image processing unit 602 and the compression unit 604 can compress the image data from the image sensor into compressed raw image data by relatively high compression ratios while remaining visually lossless or substantially visually lossless. Additionally, although the image data has been transformed (e.g., by the subtraction of green image data), the transformation can reversible. Moreover, the compressed image data according to certain implementations is still raw. For example, the compressed raw data can be decompressed, gamma corrected or otherwise display processed, color corrected, tonally processed and/or demosaiced using any custom version of those processes that the user desires.

A track separation unit 606 receives the compressed image frames from the compression module 604 and separates the image frames into n tracks, where n is determined in response to a camera setting that is selected based on how many different virtual production backgrounds the virtual production display screens 202 are currently displaying. For example, referring to the example shown in FIG. 5, the day scene, night scene, and green screen frames each correspond to every third frame. The track separation unit 606 extracts each compressed day scene frame, each night scene frame, and each green screen frame from a serial stream of compressed frames received from the compression unit 604, organizes the respective extracted frames into three separate streams, and outputs the streams to the file formatting unit 608. In other implementations, the track separation unit 606 can be positioned before the image processing unit 602 and compression unit 604.

The file formatting unit 608 receives the n separated tracks 607a-607n of compressed image frames and formats the tracks into three separate files. The file formatting unit 608 can organize the data within the frames into a specific file format. As one example, the file formatting unit 608 can organize the files according to the REDCODE RAW R3D file format. In some embodiments, the file formatting unit 608 organizes the files in a resolution-based format such as any of those described in U.S. Pat. No. 9,906,764, the entirety of the disclosure of which is hereby incorporated by reference herein. The file formatting unit 608 outputs n files 614a-614n corresponding to the n separate files for writing to the camera memory device or for streaming files off of the camera.

The image processing unit 602 can also output a separate stream directly to the track separation unit 606, thereby bypassing the compression unit 604. This can be for recording to memory or streaming uncompressed files 614a-614n via a streaming adapter, after processing by the file formatting unit 608, or for streaming uncompressed streams 618a-618n for monitoring via the monitoring outputs. In such cases, the image processing unit 602 may apply certain processing steps to the image data such as certain denoising operations, but without applying any processing steps related to compression, like pre-emphasis compression tuning or green-average subtraction.

As shown, the track separation unit 606 can additionally output separated tracks 616a-616n (e.g., uncompressed image data), e.g., for monitoring purposes to a display processing unit 612. The display processing unit 612 can receive the separated tracks and apply certain image processing operations, such as gamma correction or other display processing functions customized to one or more monitors/displays connected to the camera. The display processing unit 612 outputs the processed tracks 618a-618n. For instance, referring to FIG. 5, the processed tracks 618a-618n can be output to the output ports 518a-518n. The image processing system 600 can further include a decompression module 610 that can decompress recorded footage stored in on-board camera storage and provide it to the display processing unit 612 for streaming to the monitoring outputs.

### II. High Dynamic Range Video Systems and Methods Using Multi-track Recording

Cameras capable of capturing differently exposed digital video tracks can be used to generate high-dynamic range footage. For example, according to embodiments described herein, a camera can capture at least two tracks during each frame period using a global shutter. The first track (e.g., “base track” or “A-track”) can have a first exposure level and a second track (e.g., “highlight track”or “X-track”) at a relatively lower exposure level.

The A-track may generally accurately depict image areas in the shadows or those having standard lighting conditions, which may be under-exposed in the X-track, whereas the X-track can generally accurately depict areas in the highlights that may be blown out, clipped, or otherwise overly exposed in the A-track.

An image processing system can combine image data from the A-track and X-track to generate a combined HDR video track that includes primarily A-track pixel data in darker image regions and in those image regions having typical lighting conditions. In highlight regions, the system can include primarily X-track pixel data. Finally, the system can blend together the A-track and X-track pixel data in certain image regions, such as those regions having intermediate exposure levels.

Blending of differently exposed tracks can result in so-called “ghosting” effects, particularly in regions of the image where moving objects are present. This can be due to the temporal difference between when the A-track exposure and the X-track exposures occur, such as when each X-track exposures shortly after each corresponding A-track exposure in time. Ghosting can also be due to different amounts of motion blur will be present in the A-track and the X-track, such as where the A-track has a longer exposure time than the X-track, and therefore has more significant blurring than the X-track, in which the moving objects can have sharper edges. In such cases, multiple instances of the moving object can appear in the blended video, some of which appear semi-transparent, and look like “ghosts” of a primary instance of the object.

Post-processing systems can employ sophisticated image processing techniques to reduce ghosting and otherwise create a desired aesthetic in the blended HDR footage. Such blending techniques can be resource and time intensive. It can therefore be impractical to use the relatively sophisticated, resource intensive techniques suitable for blending in post-processing on-camera. Users nonetheless could benefit from viewing a relatively accurate version of the blended footage on-camera, e.g., for real-time viewing on a video monitoring display connected to the camera.

Video cameras and corresponding methods are described herein for performing a fast in-camera blend with de-ghosting capability. The in-camera blending process can include analyzing data for a pixel of a frame from the first track and data for that pixel for that frame from a differently exposed track and, based on the analysis, using a heuristic, detecting whether to adjust an amount of blending to reduce ghosting. If the heuristic indicates that ghosting is likely, the amount of blending is adjusted for that pixel. This can be repeated for the pixels in the frame, resulting in a blended frame that can be incorporated into a blended HDR video track.

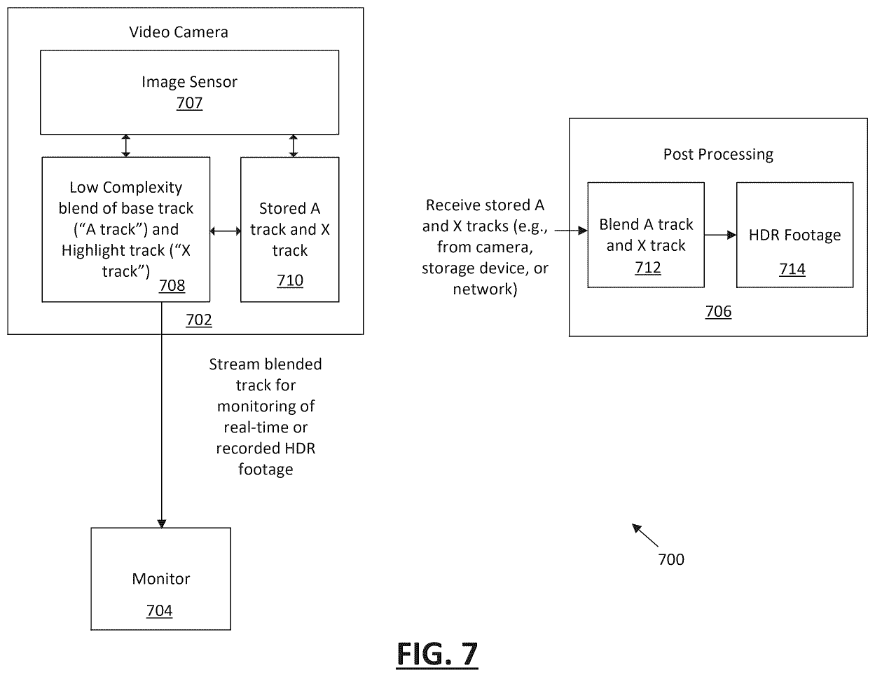

FIG. 7 depicts an embodiment of a video system 700 including a digital video camera 702 capable of capturing multiple differently exposed tracks and of streaming a fast-blended stream of the tracks to a monitor 704 (e.g., one or more LCD displays) for real-time viewing. The system further includes a post-processing computing system 706 capable of blending the tracks to produce HDR footage 714.

The video camera 702 can be any of the video cameras disclosed herein, including any of those of FIGS. 1A-1C, 2, 4A-4C, and 5, and can be configured to implement the multi-track virtual production techniques described with respect to those cameras in addition to multi-track HDR functionality described herein, e.g., with respect to FIGS. 7-10C. In one embodiment, the video camera 702 includes a 35.4 megapixel (e.g., 8192 horizontal pixels×4320 vertical pixels) global shutter CMOS sensor. As indicated previously, the global shutter sensor can capture all pixels substantially simultaneously, resulting in reduced distortion or “Jello-effect” when the subject is moving. In other embodiments, a rolling shutter can be used. In the exemplary embodiment, the camera 702 can be configured to operate at frame rates of up to 120 frames per second (e.g., at user configurable settings of 24, 48, 96, or 120 fps).

The camera 702 is configurable in an HDR mode in which at least two tracks of differently exposed video are captured. For example, the camera may be configurable to capture a base track (“A-track”) at a first exposure level corresponding to a first sensor integration time, and a second tack (“X-track”) at a second exposure level corresponding to a second sensor integration time. The A-track can have a longer integration time than the X-track, for example, making the A-track generally more suitable for shadow and standard scene content, whereas the lower exposure for the X-track makes it more suitable for capturing highlights where the A-track may be blown out or overexposed. While the terms A-track and X-track are used for convenience throughout this disclosure to represent embodiments with two captured tracks, e.g., where an A-track has a longer exposure than the X-track, other implementations are possible, such as where more than two tracks can be captured and blended.

The camera 702 includes an image sensor 707, which can be configured to capture a first image (e.g., an A-track image) followed by a second image (e.g., an X-track image) for each video frame. As an example, where the camera 702 is configured to shoot 24 frames pers second, the camera 702 can be configured to capture 24 A-track frames and 24 X-track frames per second, where the A-track frame is captured first during each 1/24 second frame interval, followed by the X-track frame. In other cases, the order of capture can be swapped and the X-track sub-frame can be captured before the A-track sub-frame. In some alternative embodiments, a first sensor (or first subset of sensor pixels) captures the A-frame and a second sensor (or second subset of sensor pixels) captures the X-frame, e.g., in parallel or overlapping in time.

As shown, the video camera 702 can be configured to store the A-track and the X-track in on-camera storage 710, which can be a CFEXPRESS card or other type of memory device. In some cases, the footage can be stored in memory of a module attached to the camera or streamed off the camera to another location for storage.

While not shown in FIG. 7 for simplicity, the video camera 702 can include an image processing system, which can be configured to process and/or compress the captured data prior to storage. For example, depending on the configuration, the video camera 702 can apply raw compression algorithm such as the REDCODE RAW codec, or apply another type of compression such as ProRes prior to writing the compressed video data to the on-camera storage 710.

The post-processing system 706 can be a computer running image processing software that applies post-processing functionality including HDR blending. The post-processing system 706 can be configured to access the A-track and X-track footage recorded by the video camera 702 via a network storage location, memory card, direct connection to the camera, or another means. A blending module 712 can be configured to blend the A-track and the X-track to create HDR footage 714. The post-processing system 706 can include a relatively high-performance processor with sufficient memory to apply sophisticated blending techniques. For example, the blending techniques may involve sophisticated techniques that involve the use of sophisticated interpolation and other processing, e.g., which can help reduce ghosting and provide other aesthetic benefits in the blended footage 714. Such processing can involve extensive use of data from multiple frames, full color image data from all color channels, spatial data from surrounding pixels, and the like.

The video camera 702, on the other hand, can include an on-camera blending module 708 that can implement a “fast” or reduced complexity blend of the A-track and X-track on-camera. The reduced-complexity blend can have sufficiently low complexity such that it can be performed in real time for streaming blended video frames, e.g., via HD-SDI port(s) to a monitor 704 for real-time viewing on the monitor 704, which can comprise one or more LCD displays.

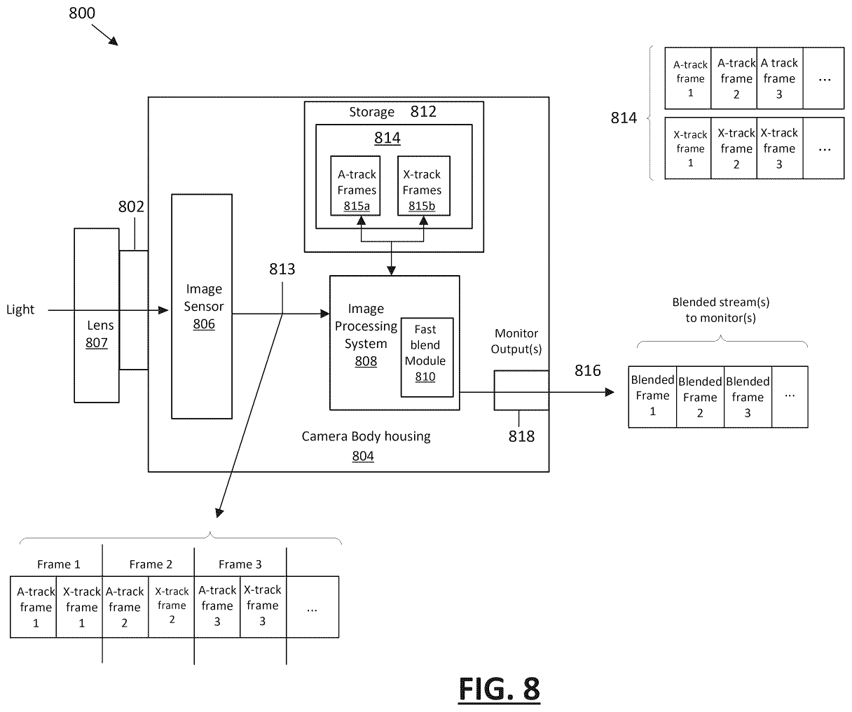

The on-camera blending module 708 can analyze data for a pixel from the A-track together with data for that pixel from the X-track using any of the techniques described herein, e.g., using a heuristic to detect whether an amount of blend should be adjusted to reduce ghosting. If the heuristic indicates that ghosting is likely, the blending module 708 adjusts the amount of blending between the two frames for that pixel. This process is repeated for each pixel in the frame to generate a blended frame. Further details regarding embodiments of the reduced-complexity blend will be provided herein, e.g., with respect to FIGS. 8-10C. While not shown in FIG. 7 for simplicity of illustration, an image processing system can process the image data received from the image sensor 707 prior to the image data being received by the blending module 708, e.g., to apply black offset correction, demosaicing, white balance, gain, color matrix processing, display correction (e.g., gamma or log encoding), or the like.

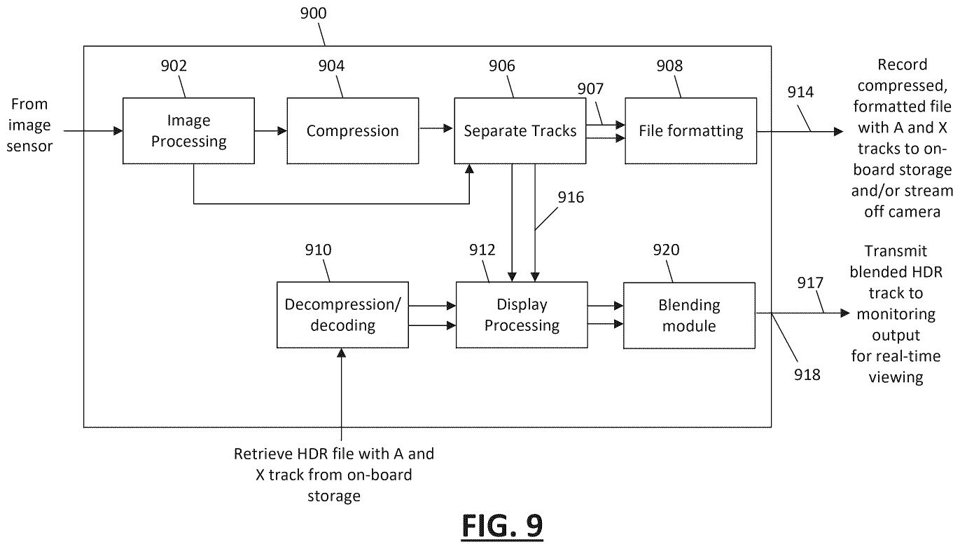

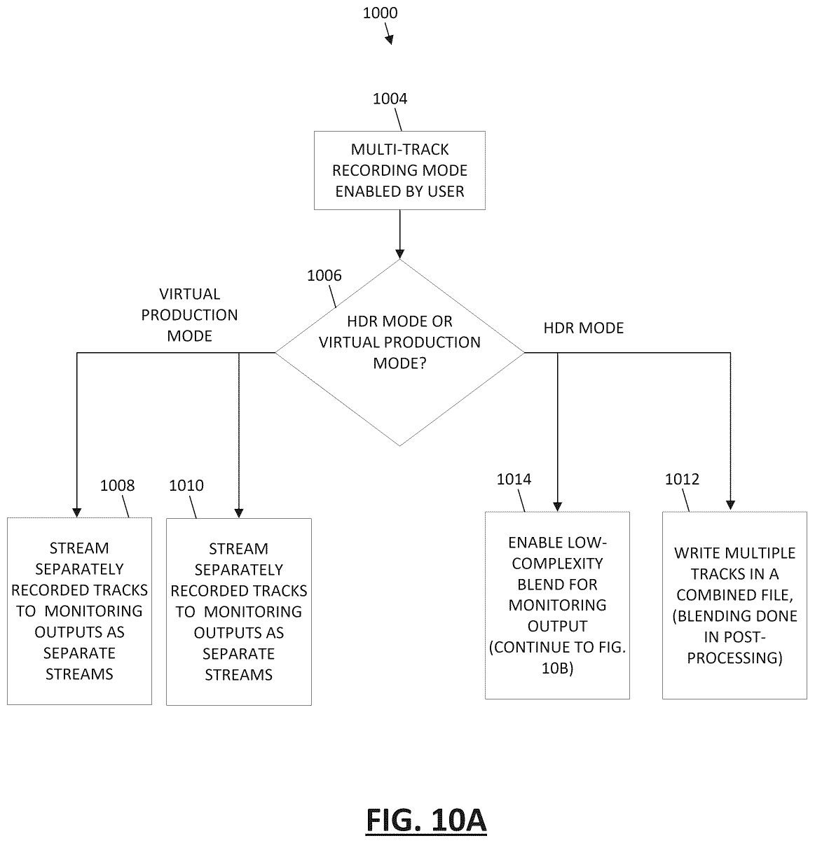

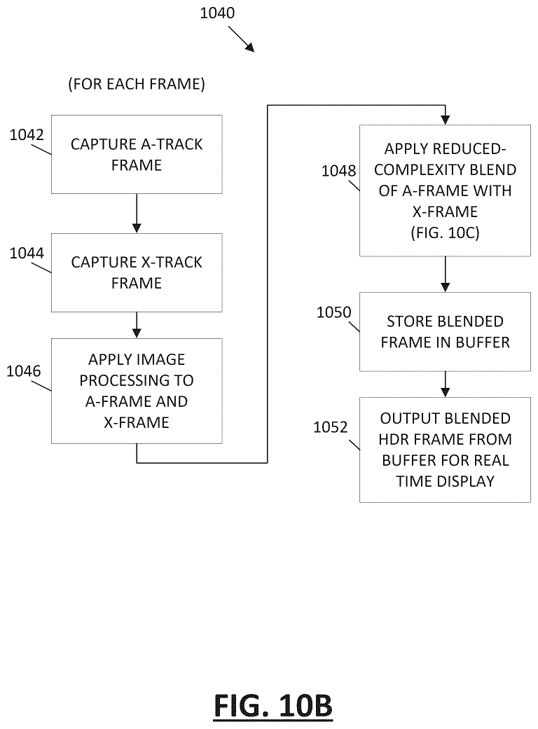

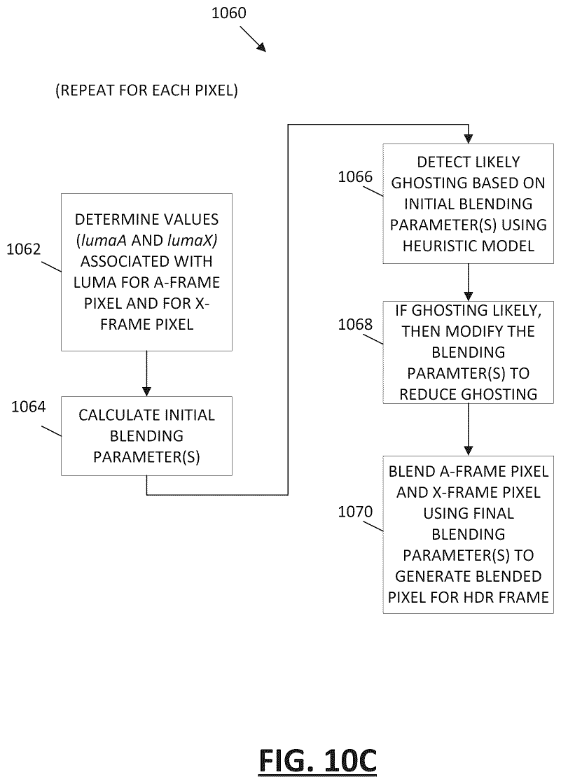

FIG. 8 depicts a schematic block diagram of a video camera 800 capable of recording multi-track video and performing a reduced-complexity fast-blend of the video for monitoring. The video camera 800 can be the video camera 702 of FIG. 7, for example, can include the image processing system 900 of FIG. 9, and/or implement any of the techniques described with respect to FIGS. 10A-10C. Moreover, the video camera 800 can include some or all the components and functionality of the video cameras described with respect to 1A-6, and thus the video camera 800 can be additionally capable of multi-track recording for virtual production as described with respect to those embodiments. For example, the video camera 800 can be configured with multiple user-selectable multi-track recording modes, including at least one for virtual production, and at least one for HDR recording in which a reduced-complexity blend can be employed for pre-view of HDR footage. According to certain embodiments, the camera can only be configured in one of these modes at any given time.

The camera 800 includes a lens mount 802, which can be fixedly or releasably attached to the camera body housing 804, with the lens mount 802 configured to accept a lens 807 (e.g., a standard lens or a fisheye lens).

As shown, the camera 800 further includes an image sensor 806 contained within the camera body housing 804. The image sensor 806 can be for example, but without limitation, CMOS, CCD, or a multi-sensor array using a prism to divide light between the sensors. The image sensor 806 can further include a Bayer pattern color filter array. In some configurations, video camera 800 can be configured to output video at 2 k” (e.g., 2048×1080 pixels), “4 k” (e.g., 4,096×2,160 pixels), “4.5 k,” “5 k,” “6 k,” “8 k” (e.g., 8192'4320), “16 k”, or greater resolutions. In one embodiment, image sensor is a 35.4 megapixel (8192 horizontal pixels×4320 vertical pixels) global shutter Bayer pattern CMOS sensor. In an exemplary embodiment, the camera 800 can be configured to operate at frame rates of up to 120 frames per second (e.g., at user configurable settings of 24, 48, 96, or 120 fps).

The image sensor 806 can output raw digital image data mosaiced according to the color filter array, such as the example Bayer pattern color filter array. The image processing system 808 can be implemented by software or firmware executing on one or more processors within the camera body housing 804, although in some embodiments the image processing system 808 or portions thereof can be implemented in specialized hardware such as an application-specific integrated circuit (ASIC).

The image processing system 808 receives the raw mosaiced digital image data from the image sensor 806 and can perform one or more functions on the raw mosaiced digital image data to aid in compressing the image data while maintaining the raw, mosaiced nature of the digital image data, and while maintaining substantially visually lossless image quality through compression. According to some embodiments, examples of functionality that can be provided by the image processing system 808 are described in U.S. Pat. No. 10,582,168, titled GREEN IMAGE DATA PROCESSING, which is hereby incorporated by reference herein in its entirety.

Depending on the embodiment, the image processing system 808 can be configured to compress and/or otherwise process continuous video, e.g., at frame rates of 23.98, 24, 25, 29.97, 30, 47.96, 48, 50, 59.94, 60, 72, 120, 240, 250, frames per second, or other frame rates between these frame rates or greater.

The image processing system 808 can receive a serial stream 813 of frames captured by the image sensor 806 at a rate that is at least n times the frame rate of the n individual tracks. For example, where the camera 800 is configured to operate in both a virtual production multi-track mode and an HDR multi-track mode, when the camera 800 is in the virtual production multi-track mode, the serial stream 813 can operate as discussed with respect to FIG. 5. When in the HDR multi-track mode, if the camera 800 is set to record two tracks (n=2) (e.g., a base “A” track and a highlight “X” track) corresponding to two different exposure levels at 24 fps, the camera 800 can respond to this setting to internally configure the sensor 806 to capture sequential frames at 2*24 fps=48 fps, where each frame alternates between exposure levels, e.g., different sensor integration times. In some other embodiments, the camera 800 may record more than two tracks at different exposure levels (e.g., where n=3 or more).

The image processing system 808 receives the image frame stream 813 from the image sensor 806, performs image processing on the frames as desired (e.g., to compress each frame), organizes the frames into separate tracks, organizes the tracks into a file 814 such as by adding appropriate metadata, and writes the file 814 in a memory card or other type of memory device 812. FIG. 8 shows two example tracks, an A-track having a higher exposure (e.g., longer integration time for shadows and standard lighting regions of the image scene), and an X-track having a lower exposure (e.g., shorter integration time for highlight regions of the image scene). In the illustrated embodiment, and unlike the virtual production multi-track mode illustrated, e.g., with respect to FIG. 5, the video camera 800 of FIG. 8 when configured in the HDR multi-track mode writes the stored A-track 815a and X-track 815b to a single file 814 instead of separate clips or files.

In addition to being capable of writing the file 814 to the memory device 812, the camera 800 can output one or more blended HDR streams 816 to one or a plurality of monitoring ports 818. While only one monitor ports 818 is shown in FIG. 8, the camera 800 can have multiple ports, e.g., three monitor ports like the ports 420a-420c of the camera 400 of FIGS. 4A-4C. In such cases, the HDR stream 816 can be replicated on the other ports or different content can be sent to the other ports (e.g., a blended HDR stream to one port, just the X-track to a second port, and just the A-track to a third port).

FIG. 9 shows an example of image processing system 900, which can be used as the image processing system 808 of FIG. 8. The image processing system 900 can comprise software or firmware implemented one or more microprocessors, or one or more ASICs or other custom hardware, or any combination thereof. While the image processing system 900 will be described primarily with respect to a HDR multi-track operational mode, the image processing system 900 can additionally be configured to implement some or all the features of the image processing system 600 of FIG. 6, such as where the image processing system 900 is part of a camera that can be configured to implement both a virtual production multi-track mode and a HDR multi-track mode.

The image processing system 900 includes an image processing unit 902 that receives the image frame stream from the image sensor and performs appropriate image processing. As an example, where the camera 900 is configured to record or stream compressed raw data, the image processing unit 902 can be configured to perform image processing operations similar or the same to those described above with respect to the image processing system 800 of FIG. 8, e.g., to perform raw compression and output substantially visually lossless or visually lossless compressed raw image data. Thus, the image processing unit 902 and compression unit 904 can be configured together to compress the raw mosaiced image frames received by the image sensor into compressed raw mosaiced video image frames.

A track separation unit 906 receives the compressed image frames from the compression module 904 and separates the image frames into n tracks, where n is determined in response to a camera setting that is selected based on how many differently exposed tracks are in the HDR video (e.g., 2, 3, or more). For example, referring to the example shown in FIG. 8, there is an A-track and an X-track, and in such a case the track separation unit 906 extracts each compressed A-track and each compressed X-track and provides it to the file formatting unit 908. In other implementations, the track separation unit 906 can be positioned before the image processing unit 902 and compression unit 904. Or the track separation unit 906 may not be used in the HDR recording mode, and, for example, an alternating stream of A-track frames and X-track frames are output by the compression unit 904 to the file formatting unit 908 and/or the display processing unit 912.

The file formatting unit 908 can receive the n separated tracks 907 (e.g., the A-track and the X-track) of compressed image frames, and format the tracks into a single combined HDR file 914. The file formatting unit 908 can organize the data within the frames into a specific file format. As one example, the file formatting unit 908 can organize the file 914 according to the REDCODE RAW R3D file format. In some embodiments, the file formatting unit 908 organizes the file in a resolution-based format such as any of those described in U.S. Pat. No. 9,906,764, titled RESOLUTION BASED FORMATTING OF COMPRESSED IMAGE DATA, the entirety of the disclosure of which is hereby incorporated by reference herein. The file formatting unit 908 outputs the file 914 for writing to the camera memory device or for streaming files off of the camera.

The image processing unit 902 can also output a separate stream directly to the track separation unit 906, thereby bypassing the compression unit 904. This can be for recording to memory, or for streaming, an uncompressed file 914 via a streaming adapter, after processing by the file formatting unit 908, or for streaming an uncompressed stream 917 for monitoring via a monitoring output 918. In such cases, the image processing unit 902 may apply certain processing steps to the image data such as certain denoising operations, but without applying any processing steps related to compression, like pre-emphasis compression tuning or green-average subtraction.

As shown, the track separation unit 906 can additionally output the tracks 916 (e.g., uncompressed A-track and X-track image data), e.g., for monitoring purposes to a display processing unit 912. The display processing unit 912 can apply image processing operations including some or all of black offset removal, white balance, demosaicing, color matrix processing, display correction such as gamma or log encoding, and gain. In other embodiments, some such functions can be performed by the image processing unit 902. The display processing unit 912 outputs the processed tracks to the blending module 920. The image processing system 900 can further include a decompression module 910 that can decompress recorded footage stored in on-board camera storage and provide it to the display processing unit 912 for processing prior to streaming to the monitoring output 918.

The blending module 920 can perform a reduced-complexity blend, e.g., with de-ghosting capability, for real-time monitoring purposes. For example, the blending module 920 can apply an algorithm that creates a blended track including solely A-track pixel values for first image regions (e.g., shadows and some standard lit portions), solely X-track pixel values for second image regions (e.g., highlights), and a blend of A-track and X-track pixel values for other regions. In performing the blending, the blending module 920 can employ a heuristic model to detect whether an initial amount of blending is likely to cause ghosting, and if so, apply a modified amount of blending (e.g., less or no blending) for that pixel. For example, the blending module 920 can be the blending module 708 of FIG. 7 or the blending module 810 of FIG. 8, and can operate in the manner described in further detail with respect to the methods of FIGS. 10A-10C. The blending module 920 outputs the blended HDR stream 917, e.g., to one or multiple monitoring ports 918 for real-time viewing.

FIG. 10A shows a flow chart of an example method 1000 of multi-track camera operation depending on user selection of a virtual production multi-track mode or an HDR multi-track mode. FIG. 10B shows a flow chart 1040 of an example of a method for capturing multiple differently exposed video tracks and performing a reduced-complexity blend of the tracks, e.g., for real time monitoring/viewing. FIG. 10C shows a flow chart 1060 of an example of a method 1060 for performing a reduced-complexity blend of multiple differently exposed video tracks.

Although the flow charts 1000, 1040, 1060 will primarily be described with respect to the multi-track operation described thus far with respect to the cameras FIGS. 7 and 8 and the image processing system 900 of FIG. 9, any of the cameras described herein can perform the techniques described with respect to FIGS. 10A-10C.

Referring to FIG. 10A, at block 1004 the method (e.g., via software executing on a control processor of the camera) determines that a multi-track recording mode has been enabled by a user, e.g., using an on-camera graphical user interface, wired or wireless connected remote, or other control input. The method determines at block 1006 which multi-track mode has been enabled. If a virtual production multi-track mode has been enabled, the camera operates to record multiple tracks to separate files at block 1008, e.g., in the manner described with respect to FIGS. 1A-6. At block 1010 the method can also include streaming the separately recorded virtual production tracks to separate monitoring outputs as separate streams, e.g., as described with respect to FIGS. 5 and 6. As such, the method according to certain embodiments allows for use of only one of the multi-track recording modes at a given time.

If, on the other hand, the method determines at block 1006 that the user has enabled the HDR multi-track mode, the method at block 1012 writes the multiple tracks into a combined file at block 1012, as described, for example, with respect to the camera 800 of FIG. 8 and the image processing system 900 of FIG. 9.

In addition, the method at block 1014 enables the on-camera blend of the tracks for blended monitoring output, e.g., as described with respect to the camera 800 of FIG. 8 and the image processing system 900 of FIG. 9.

As indicated, the method can continue to the flow chart 1040 of FIG. 10B, which shows further details of the in-camera blend process according to certain embodiments. The flowchart 10104 can generally be repeated for frame, to thereby generate a blended image for each video frame.

At block 1042, the method includes using the image sensor (e.g., a CMOS global shutter sensor) of the camera to capture an A-track frame (which can also be called a sub-frame) within a sub-frame period of the recording frame period, which is set by the user-selected frame rate. At block 1044, the method captures an X-track frame (which can also be called a sub-frame) with the image sensor within a second sub-frame period. The A-track frame can have a higher exposure (e.g., longer integration time) than the X-track frame, for example. For example, in one embodiment, the X-track frames may have an exposure that is 4 stops under exposed as compared to the A-track. In this case, the integration time for the A-track can be 16 times that of X-track, although other relative exposure levels and integration times can be employed. Thus, where the camera is set to 24 fps, the method will use the image sensor to capture 24 X-track sub-frames and 24 A-track sub-frames each second, e.g., where the X-track sub-frames and A-track sub-frames alternate such that one X-track sub-frame and one A-track sub-frame are captured in each 1/24 second frame period.

At block 1046, the method can include applying certain image processing operations to the A-frame and the X-frame. For example, where the image sensor is a Bayer sensor, the method can include performing some or all of the following on the raw RGB data: black offset removal, white balance, demosaic/deBayer, color matrix processing, gain, and log encoding. For example, the method can include applying one or more of black offset removal, white balance, and demosaic, followed by gain, then color matrix processing, and then log encoding. For example, one or more processing units executing on a processor of the camera can perform these operations, such as the image processing system 808 of the camera 800 of FIG. 8 or the image processing system 900 of FIG. 9.

The gain operation referred to above can adjust values of pixels in one or more of the sub-frames to balance tonal values between the sub-frames prior to blending. In some embodiments, for example, the method applies a gain to the pixels in the X-frame to match the tonal values of the X-frame with the tonal values of the A-frame. This is because the X-frame is underexposed with respect to the A-frame, and applying the gain will result in better tonal matching in the blended image. In one embodiment, the X-frame is underexposed by 4 stops with respect to the A-frame, and each pixel in the X-frame is therefore multiplied by 16 (2\hat{ }4) at block 1048. By performing the gain operation prior to (or as part of the math of) the log encoding, relatively large gain can be applied to the data while avoiding clipping. Moreover, applying log prior to blending can preserve enough dynamic range in the data to produce sufficiently wide dynamic range or HDR footage.

At block 1048, the method includes performing the on-camera blend algorithm. FIG. 10C shows a flow chart 1060 showing an example of the on-camera blend algorithm according to certain embodiments, which can be repeated for each pixel in the frame.

At block 1062, the method includes, for the current pixel, calculating values (lumaA and lumaX) associated with luma (or brightness or intensity) of that pixel in the A-frame and in the X-frame, respectively. In some implementations, the values associated with the luma can be determined by taking the minimum of the “RGB triple” for the pixel. In such cases, at block 1062, the method calculates lumaA and lumaX by selecting the minimum of the R, G, and B intensity values in the RGB triple for the pixel in the A-frame and in the RGB triple for the pixel in the X-frame. For instance, if the measured intensity values are normalized to a range between 0 and 65535 for 16-bit data, where R=5000, G=5100, B=4950 in the A-frame, and R=5050, G=5150, B=5000 in the X-frame, lumaA would be 4950(min[5000, 5100, 4950]), and lumaX would be 5000 (min[5050, 5150, 5000]). Using a single value of the RGB triple can be desirable for avoiding a color dependent blend, and also to aid real-time implementation because it does not involve significant computation. lumaA and lumaX can be determined in different manners depending on the implementation, such as by taking any of the following of the RGB triple: maximum, middle, average, average of minimum and maximum, and weighted average (e.g., of R, G, and B or of any two of R, G, and B).

After calculating the values associated with luma, lumaA and lumaX, for the current pixel in each frame, the method calculates an initial value of a blending coefficient (α_at block 1064. As will be seen, a final value (α_f) of the blending coefficient will eventually be determined and used to set how much of the A-frame content and how much of the X-frame content for the current pixel will be used in the final blended value for the current pixel in the HDR image. In some implementations, the initial value (α_i) of the blending coefficient is calculated based on lumaA and one or more thresholds. For example, the initial blending coefficient value can be calculated by the following equation:

$$if lumaA < th\_L , α\_i = 0 ;$$

$$if lumaA > th\_U α\_i = 1 ;$$

else α_i=CLAMP (((lumaA−th_L)/(th_U−th_L)), 0, 1), where th_L is a lower threshold, and th_U is an upper threshold.

The above equation will result in the initial blending coefficient being clamped to α_i=0 if lumaA is below th_L, which indicates, for example, that the image content is likely of relatively lower exposure (e.g., in shadow regions of image), and that the A-frame pixel is therefore probably more properly exposed than the X-frame pixel.

On the other hand, the equation will result in the initial blending coefficient being clamped to α_i=1 if lumaA is above th_U, which indicates, for example, that the image content is of relatively higher exposure and potentially clipped or blown out (e.g., highlight image regions), and that the X-frame pixel is therefore probably more properly exposed than the A-frame pixel. It can be seen from the above equation that calculating lumaA based on the minimum of the RGB triple can result in a conservative indication as to whether there is clipping.

Finally, for values between th_L and th_U, the function will result in α_i being equal to a value between 0 and 1 proportional to how far lumaA is above th_L, where the closer lumaA is th_L, the closer α_i is to 0, and the closer lumaA is to th_U, the closer α_i is to 1.

After calculating the initial blending coefficient, the method at block 1066 uses a heuristic model to detect whether ghosting would be likely if the initial blending coefficient is used to blend the pixels. According to some embodiments, the heuristic model is used to efficiently determine whether ghosting is likely using information derived only from the current pixel, without spatial information from other pixels or temporal information from prior or future frames.

In some example implementations, the method determines whether ghosting is likely by calculating a blended luma value (lumaBl) based on lumaA, lumaX, and α_i, and comparing lumaBl to lumaA. Because lumaBl is derived from lumaA and lumaX, which utilize only a single value of the RGB triple for each respective sub-frame, calculation of the lumaBl value is relatively straightforward and not resource intensive.

If lumaBl is greater than or equal to lumaA, the heuristic indicates that ghosting is relatively unlikely, and the final blending coefficient (α_f) is set equal to the initial blending coefficient (α_i). If, on the other hand, if lumaA is greater than lumaBl, the heuristic indicates that ghosting is relatively likely, and adjusts the blending coefficient, such that, the more lumaA is greater than lumaBl, the further the blending coefficient will be adjusted towards ‘0’, resulting in less blend for that pixel (more A-track and less X-track for that pixel). Such an implementation can be achieved using the following equation:

```
if (lumaBl < lumaA)
{
  β=CLAMP((lumaA − lumaBl) / threshold), 0, 1);
  α_f = (1−β)*α_i;
}
else { α_f = α_i } //lumaA < = lumaBl.
```

According to the above function, if lumaA is less than or equal to lumaBl, the heuristic indicates ghosting is unlikely, and the blending coefficient is unmodified (α_f=α_i). This can be a good heuristic because it indicates that the A-track is darker than the blended track, which in a normal non-ghosted blending situation should often be the case because the blend often adds highlight information from the X-track, resulting in a blended pixel that is brighter than the pixel of the A-track pixel alone.

On the other hand, if lumaA is greater than lumaBl (written in the equation above as lumaBl<lumaA), the method at block 1068 determines that ghosting is likely, and modifies the blending coefficient. For instance, according to the example implementation set forth in the above function, the method follows the “else” branch of the above equation as follows.

If lumaA is greater than lumaBl by a threshold amount (threshold), the heuristic indicates that blending will be unsuccessful, e.g., due to substantial ghosting or noise. Under these circumstances, the CLAMP function results in β=1, and α_f=0 ([1−1]*α_i), which will result in no blending (all A-track and no X-track in the blended pixel).

If lumaA is greater than lumaBl by an amount less than threshold, the heuristic adjusts the blending coefficient downwards by an amount proportional to lumaA−lumaBl. Under these circumstances, the CLAMP function results in 0<β<1, and the final blending coefficient (α_f) will be set to the initial blending coefficient (α_i) reduced by an amount proportional to β according to α_f=(1−β)*α_i. In this manner, the method uses the heuristic to determine that, the further lumaA is above lumaBl, the more likely use of the initial blending coefficient (α_i) is to result in ghosting, and thus, the more the method will adjust the final blending coefficient (α_f) downwards to incorporate less of the X-track in the final blended pixel.

At block 1070, the method blends the pixels from the sub-frames together with the final blending parameters. For example, in an example implementation, the A-frame pixel pixel can be blended together with the X-frame pixel using the final blending coefficient α_f according to an linear interpolation as follows:

$$* RBl = ( RA * [ 1 - α\_f ] + RX * α\_f ) ;$$

$$* GBl = ( GA * [ 1 - α\_f ] + GX * α\_f ) ;$$

$$* BBl = ( BA * [ 1 - α\_f ] + BX * α\_f ) ,$$

where RA, GA, BA is are the red, green, and blue intensity values for the A-frame pixel, RX, GX, BX is are the red, green, and blue intensity values for the X-frame pixel, and *RBl, *GBl, *BBl, are the red, green, and blue intensity values for the blended pixel. According to the above equation, a_f=0 results in the blended pixel being set equal to the A-frame pixel, a_f=1 results in the blended pixel being set equal to the X-frame pixel, and 0<a_f<1 results in blending between the A-frame and the X-frame.

While this equation represents one example blending algorithm, other algorithms can be used depending on the implementation.

The method then repeats blocks 1062-1070 for each pixel in the frame to generate a blended image frame including portions of the A-frame and portions of the X-frame. As mentioned previously, the blend can be following log encoding of the image data. Blending in log can help preserve enough dynamic range to produce a sufficiently HDR image. Although in some cases gamma encoding could be used, using log encoding can be less restricted and provide encoding sufficient to produce sufficiently HDR blended image.

Returning to the flow chart of FIG. 10B, the method moves on to block 1050 to store the blended frame in a memory buffer. The method can further involve applying a display transform to the blended frame to convert the image for display. For example, the method can convert the log-encoded blended image frames using the perceptual quantizer (PQ) transfer function for HDR display according to the Society of Motion Picture and Television Engineers (SMPTE) standard, SMPTE ST 2084 (PQ). In some embodiments, the a hybrid log-gamma (HLG) transfer function is applied to the blended frames for HDR display. At block 1052, the method includes outputting the blended frame from the buffer, e.g., to a monitoring port for delivery to a display attached to the video camera.

The on-camera blending algorithms described herein, according to certain embodiments, can include some or all of the following aspects, which can reduce the complexity of the blending operation and facilitate real-time operation for monitoring purposes: 1) blending on a single pixel basis, where data from a single pixel in multiple sub-frames is blended without including additional spatial data from other pixels, 2) blending on a single frame basis, where data from a pixel in multiple sub-frames is blended together without including temporal data from other frames, 3) setting a blending coefficient or other blending parameter based on pixel data from a single color in each sub-frame (e.g., a minimum of an RGB triplet from one or both sub-frames), without averaging or other operations involving additional color data, 4) setting an initial value of a blending coefficient or other blending parameter based on data from a single sub-frame (e.g., the minimum of RGB triplet from an A-track sub-frame), 5) determining whether ghosting is likely based on data from a single pixel in each sub-frame and/or data from a single color from each sub-frame pixels (e.g., minimums of RGB triplets in the A-track and X-track pixels). In some alternative embodiments, the de-ghosting heuristic is not applied, resulting in an even more reduced complexity on-camera blend. In some such implementations, the user can select whether or not the de-ghosting is applied to the in-camera blend.

Unless the context indicates otherwise, throughout the description and the claims, the words “comprise,” “comprising,” “include,” “including” and the like are to generally be construed in an inclusive sense, as opposed to an exclusive or exhaustive sense; that is to say, in the sense of “including, but not limited to.” Conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure.

What is claimed is:

1. A video camera system comprising:
an image sensor comprising an array of sensor pixels, the image sensor configured to capture digital video frames in response to light incident on the array of sensor pixels; and
one or more processors configured, when the video camera system is operating in a first multi-track recording mode, to:
receive a stream of digital video frames from the image sensor, wherein each of the digital video frames comprise a first sub-frame having a first exposure level and a second sub-frame having a second exposure level different than the first exposure level;
for each respective frame of a plurality of digital video frames in the stream, for each respective pixel of a plurality of pixels in the frame:
determine an initial value of a blending parameter for the respective pixel using image data for the respective pixel in the first sub-frame of the respective frame;
detect whether ghosting is likely to result from using the initial value to blend the respective pixel of the first sub-frame together with the respective pixel of the second sub-frame;
determine a final value of the blending parameter in response to the detection of whether ghosting is likely; and
use the final value to blend the respective pixel of the first sub-frame together with the respective pixel of the second sub-frame to generate a blended pixel, the blended pixel included in a blended digital video frame corresponding to the respective frame; and
the one or more processors further configured, when the video camera system is operating in the first multi-track operating mode, to output a stream of the blended digital video frames for monitoring.

2. The video camera system of claim 1 wherein the one or more processors are configured to determine the initial value of the blending parameter using first image data corresponding to a single color of the respective pixel in the first sub-frame.

3. The video camera system of claim 2 wherein the first image data is a minimum R, G, or B value of an RGB triplet of the respective pixel of the first sub-frame.

4. The video camera system of claim 2 wherein the one or more processors are configured to detect whether ghosting is likely based on i) the first image data corresponding to a single color of the respective pixel in the first sub-frame and ii) second image data that corresponds to a single color of the respective pixel in the second sub-frame.

5. The video camera system of claim 4 wherein the one or more processors are configured to:
use the initial value of the blending parameter to blend the first image data and the second image data to generate blended image data; and
detect whether ghosting is likely by comparing the first image data to the blended image data.

6. The video camera system of claim 4 wherein the first image data corresponds to a minimum R, G, or B value of an RGB triplet of the respective pixel of the first sub-frame, and the second image data corresponds to a minimum R, G, or B value of an RGB triplet of the respective pixel of the second sub-frame.

7. The video camera system of claim 1 wherein the one or more processors are configured to: set the final value to be the initial value in response to a determination that ghosting is unlikely, and set the final value to be a value different than initial value in response to a determination that ghosting is likely, wherein the setting the final value to be a value different than the initial value results in less of the respective pixel of the second sub-frame, and more of the respective pixel of the first sub-frame, being included in the blended pixel than would have been the case if the final value were set as the final value.

8. The video camera system of claim 1 further comprising one or more monitoring ports, where the stream of the blended digital video frames is output on at least one of the one or more monitoring ports.

9. The video camera system of claim 1 wherein the one or more processors are further configured, for each frame of the plurality of digital video frames, to apply a gain to the pixels in at least the second sub-frame, and to apply log encoding to the pixels in the first and second sub-frames, the log encoding applied after the gain, wherein application of the gain balances tonal values between the first sub-frame and the second sub-frame.

10. The video camera system of claim 1 further comprising a monitoring port configured to provide the stream of blended digital video frames to a monitor connected to the monitoring port for real-time display.

11. The video camera system of claim 1 wherein the blended digital video frame has a higher dynamic range than either of the first sub-frame or the second sub-frame.

12. The video camera system of claim 1 wherein, when the video camera system is operating in a second multi-track recording mode, the one more processors are configured to:
receive a stream of the digital video image frames from the image sensor, wherein each of the digital video frames comprise a first sub-frame that captures a first virtual production background and a second sub-frame that captures a second virtual digital production background;
separate the first sub-frames into a first track and the second sub-frames into a second track; and
output the first track and the second track as separate streams.

13. The video camera system of claim 12 wherein, when the video camera system is operating in the first multi-track recording mode, the one or more processors are configured to write the stream of the blended digital video frames is written in a single file to memory, and when the video camera is operating in the second multi-track recording mode, one or more processors are configured to write the first track and the second track as separate files to memory.

14. The video camera system of claim 12 further comprising at least two monitoring ports, wherein, when the video camera system is operating in the first multi-track recording mode, the stream of blended digital video frames is output on at least one of the at least two monitoring ports, and wherein, when the video camera is operating in the second multi-track recording mode, the first track is output on a first of the at least two monitoring ports and the second track is output on a second of the at least two monitoring ports.

15. A method of operating a video camera system, the method comprising:
when the video camera system is operating in a first multi-track recording mode:
capturing digital video frames using an image sensor of the camera system in response to light incident on an array of sensor pixels;
receiving a stream of digital video frames from the image sensor, wherein each of the digital video frames comprise a first sub-frame having a first exposure level and a second sub-frame having a second exposure level different than the first exposure level;
with one or more processors of the video camera system, for each respective frame of a plurality of digital video frames in the stream, for each respective pixel of a plurality of pixels in the frame:
determining an initial value of a blending parameter for the respective pixel using image data for the respective pixel in the first sub-frame of the respective frame;
detecting whether ghosting is likely to result from using the initial value to blend the respective pixel of the first sub-frame of the frame together with the respective pixel of the second sub-frame;
determining a final value of the blending parameter in response to the detection of whether ghosting is likely; and
using the final value to blend the respective pixel of the first sub-frame together with the respective pixel of the second sub-frame to generate a blended pixel, the blended pixel included in a blended digital video frame corresponding to the respective frame; and
outputting a stream of the blended digital video frames for monitoring.

16. The method of claim 15 wherein the determining the initial value of the blending parameter comprises using first image data corresponding to a single color of the respective pixel in the first sub-frame.

17. The method of claim 15 further comprising outputting the stream of the blended digital video frames to at least a first monitoring port of one or more monitoring ports of the video camera system.

18. The method of claim 15 further comprising, for each frame of the plurality of digital video frames in the stream, applying a gain to the pixels in the second sub-frame to balance tonal values between the first sub-frame and the second sub-frame.

19. A video camera system comprising:
an image sensor; and
one or more processors configured, when the video camera system is operating in a multi-track recording mode, to:
receive a stream of digital video frames from the image sensor, wherein each of the digital video frames comprise a first sub-frame having a first exposure level and a second sub-frame having a second exposure level different than the first exposure level;
for each respective frame of a plurality of digital video frames in the stream, for each respective pixel of a plurality of pixels in the frame:
analyze pixel data for the respective pixel from the first sub-frame and pixel data for the respective pixel from the second sub-frame to determine whether to adjust an amount of blend from a first blending amount to a second blending amount; and
use the amount of blend to blend the respective pixel of the first sub-frame together with the respective pixel of the second sub-frame to generate a blended pixel.

20. The video camera system of claim 19 wherein the amount of blend used is equal to the first blending amount if the analysis indicates that ghosting is unlikely, and the amount of blend used is adjusted to the second amount of blend if the analysis indicates that ghosting is likely.
